(19) United States
(12) Patent Application Publication
(10) Pub. No.: US 2025/0063443 A1
(43) Pub. Date: Feb. 20, 2025

(54) NODE IN WIRELESS COMMUNICATION SYSTEM AND METHOD PERFORMED BY THE SAME

(71) Applicant: Samsung Electronics Co., Ltd., Suwon-si (KR)

(72) Inventors: Yanru WANG, Beijing (CN); Yu PAN, Beijing (CN); Lixiang XU, Beijing (CN); Hong WANG, Beijing (CN); Fuyuan LI, Beijing (CN)

(21) Appl. No.: 18/807,256

(22) Filed: Aug. 16, 2024

(30) Foreign Application Priority Data
Aug. 17, 2023 (CN) 202311041988.1
Apr. 3, 2024 (CN) 202410405616.0
Jul. 3, 2024 (CN) 202410889972.4

(51) Int. Cl. H04W 36/00; H04W 36/12

(52) U.S. Cl. CPC H04W 36/00838; H04W 36/12

(57) ABSTRACT

The disclosure provides a node in a wireless communication system and methods performed by the same. A method performed by a first node in a wireless communication system is provided. The method includes receiving a fifth message from a second node, wherein the fifth message includes a layer 1/layer 2 (L1/L2)-triggered mobility (LTM) handover request, and wherein the fifth message includes information of at least one candidate target cell of the first node, transmitting a sixth message to the second node, wherein the sixth message includes an LTM handover request result, receiving a second message from the second node, wherein the second message includes information of at least one candidate target cell, transmitting a third message to a third node based on the information of the at least one candidate target cell, wherein the third message includes information indicating a user equipment to handover and/or access to the first node, and receiving a fourth message from the third node and/or the second node, wherein the fourth message includes updated handover related information.

### CROSS-REFERENCE TO RELATED APPLICATION(S)

This application is based on and claims priority under 35 U.S.C. § 119(a) of a Chinese patent application number 202311041988.1, filed on Aug. 17, 2023, in the Chinese Intellectual Property Office, of a Chinese patent application number 202410405616.0, filed on Apr. 3, 2024, in the Chinese Intellectual Property Office, and of a Chinese patent application number 202410889972.4, filed on Jul. 3, 2024, in the Chinese Intellectual Property Office, the disclosure of each of which is incorporated by reference herein in its entirety.

### BACKGROUND

### 1. Field

The disclosure relates to a technical field of wireless communication. More particularly, the disclosure relates to a node in a wireless communication system and methods performed by the same.

### 2. Description of Related Art

In order to meet an increasing demand for wireless data communication services since a deployment of 4^{th} generation (4G) communication system, efforts have been made to develop an improved 5^{th} generation (5G) or pre-5G communication system. Therefore, the 5G or pre-5G communication system is also called “beyond 4G network” or “post long-term evolution (LTE) system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

In layer 1/layer 2 (L1/L2)-triggered mobility (LTM) management, the user equipment (UE) can maintain configuration after handover to serve as configuration for subsequent handover. This process may have at least one of the following problems.

In this case, after the user is handed over to a target node, the target node cannot make a subsequent handover decision for the user, thus the user's performance cannot be guaranteed.

In a subsequent handover process, the user needs to use initial handover configuration to perform handover, but the initial handover configuration may not be suitable for the current situation, resulting in decreased handover robustness and impaired user performance.

The user may configure multiple candidate target cells, where one message requesting one candidate target cell, which leads to excessive signalling overhead.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a node in a wireless communication system and methods performed by the same.

Additional aspects will be set forth in part in the description which follows and, in part, will be apparent from the description, or may be learned by practice of the presented embodiments.

In accordance with an aspect of the disclosure, a method performed by a central unit (CU) of a source base station in a communication system is provided. The method includes transmitting, to at least one CU of a candidate target base station, a layer 1/layer 2 (L1/L2)-triggered mobility (LTM) handover request for triggering an LTM handover; receiving, from the at least one CU of the candidate target base station, an LTM handover request result message including at least one an identification (ID) of an accepted target cell, information for the accepted target cell or a reason for a non-accepted target cell; and as a response to the LTM handover request result message, transmitting, to a user equipment (UE), a first radio resource control (RRC) reconfiguration message including configuration information for a target cell.

In accordance with an aspect of the disclosure, a method performed by a central unit (CU) of a target base station in a communication system is provided. The method includes receiving, from a CU of a source base station, a layer 1/layer 2 (L1/L2)-triggered mobility (LTM) handover request for triggering an LTM handover; transmitting, to the CU of the source base station, an LTM handover request result message, wherein the LTM handover request result message includes at least one an identification (ID) of an accepted target cell, information for the accepted target cell or a reason for a non-accepted target cell.

In accordance with an aspect of the disclosure, a method performed by a user equipment (UE) in a wireless communication system is provided. The method includes receiving, from a central unit (CU) of a source base station, a radio resource control (RRC) reconfiguration message including configuration information for a target cell; receiving, from a distributed unit (DU) of the source base station, a handover command message; and as a response to the handover command message, accessing to a DU of a target base station.

In accordance with an aspect of the disclosure, a central unit (CU) of a source base station in a communication system is provided. The CU of the source base station comprising: a transceiver; and a controller coupled with the transceiver configured to: transmit, to at least one CU of a candidate target base station, a layer 1/layer 2 (L1/L2)-triggered mobility (LTM) handover request for triggering an LTM handover; receive, from the at least one CU of the candidate target base station, an LTM handover request result message including at least one an identification (ID) of an accepted target cell, information for the accepted target cell or a reason for a non-accepted target cell, and as a response to the LTM handover request result message, transmit, to a user equipment (UE), a first radio resource control (RRC) reconfiguration message including configuration information for a target cell.

In accordance with an aspect of the disclosure, a central unit (CU) of a target base station in a communication system is provided. The CU of the target base station comprising: a transceiver; and a controller coupled with the transceiver configured to: receive, from a CU of a source base station, a layer 1/layer 2 (L1/L2)-triggered mobility (LTM) handover request for triggering an LTM handover; transmit, to the CU of the source base station, an LTM handover request result message, wherein the LTM handover request result message includes at least one an identification (ID) of an accepted target cell, information for the accepted target cell or a reason for a non-accepted target cell.

In accordance with an aspect of the disclosure, a user equipment (UE) in a wireless communication system is provided. The UE comprising: a transceiver; and a controller coupled with the transceiver configured to: receive, from a central unit (CU) of a source base station, a radio resource control (RRC) reconfiguration message including configuration information for a target cell, receive, from a distributed unit (DU) of the source base station, a handover command message; and as a response to the handover command message, access to a DU of a target base station.

In accordance with an aspect of the disclosure, a method performed by a first node in a wireless communication system is provided. The method includes receiving a fifth message from a second node, wherein the fifth message includes an L1/L2-triggered mobility (LTM) handover request, and wherein the fifth message includes information of at least one candidate target cell of the first node, transmitting a sixth message to the second node, wherein the sixth message includes an LTM handover request result, receiving a second message from the second node, wherein the second message includes information of at least one candidate target cell, transmitting a third message to a third node based on the information of the at least one candidate target cell, wherein the third message includes information indicating a user equipment to handover and/or access to the first node, and receiving a fourth message from the third node and/or the second node, wherein the fourth message includes updated handover related information.

In accordance with another aspect of the disclosure, the method further includes transmitting a first message to the second node, wherein the first message includes a request for the information of the at least one candidate target cell, wherein the second message is transmitted to the first node by the second node based on the request for the information of the at least one candidate target cell, wherein, the first message includes one or more of the following identification of a user equipment related to handover, identification for requesting to report candidate target cell information, identification of a cell requested to report candidate target cell information, scope of candidate target cells requested to report candidate target cell information, and candidate target cell information requested to be reported.

According to embodiments of the disclosure, the method further includes transmitting a handover success message to the second node, wherein the handover success message includes information indicating that a user equipment has handed over and/or accessed to the first node.

According to embodiments of the disclosure, the method further includes transmitting a radio resource control reconfiguration message to the user equipment, wherein the radio resource control reconfiguration message includes the updated handover related information.

According to embodiments of the disclosure, candidate target cells included in the second message are provided. The candidate target cells include one or more of the following all candidate target cells of all candidate target nodes, all candidate target cells except cells of the first node, all candidate target cells of partial candidate target nodes, partial candidate target cells of partial candidate target nodes, and candidate target cells having an interface with a node to which the user equipment is currently connected.

According to embodiments of the disclosure, the method further includes making a handover decision based on the information of the at least one candidate target cell and/or the updated handover related information.

According to embodiments of the disclosure, the second message includes one or more of the following identification of a user equipment related to handover, request index, and reported candidate target cell information.

According to embodiments of the disclosure, the fourth message includes one or more of the following identification of a user equipment related to handover, updated and/or modified configuration related information, cancelled configuration related information, added configuration related information, valid time of configuration, and related information for obtaining timing advance (TA).

According to embodiments of the disclosure, the information of the at least one candidate target cell included in the fifth message includes one or more of the following identification of a user equipment related to handover, target cell identification, target node identification, LTM handover identification, request for random access channel (RACH) resource configuration for obtaining timing advance (TA), reference signal configuration request, and reference configuration.

According to embodiments of the disclosure, the sixth message includes one or more of the following identification of a user equipment related to handover, identification of accepted target cells, random access channel (RACH) resource configuration for obtaining timing advance (TA), reference signal configuration, target node configuration, reference configuration corresponding to target node configuration, identification of unaccepted target cells, and reasons for non-acceptance.

According to embodiments of the disclosure, the third message includes one or more of the following identification of a user equipment related to handover, identification of a target cell accessed by the user equipment, and identification of a target node accessed by the user equipment.

In accordance with another aspect of the disclosure provide a method performed by a second node in a wireless communication system is provided. The method includes transmitting a fifth message to a first node, wherein the fifth message includes an L1/L2-triggered mobility (LTM) handover request, and wherein the fifth message includes information of at least one candidate target cell of the first node, receiving a sixth message from the first node, wherein the sixth message includes an LTM handover request result, transmitting a second message to the first node, wherein the second message includes information of at least one candidate target cell, and transmitting a fourth message to the first node, wherein the fourth message includes updated handover related information.

According to embodiments of the disclosure, the method further includes receiving a first message from the first node, wherein the first message includes a request for the information of the at least one candidate target cell, wherein the second message is transmitted to the first node by the second node based on the request for the information of the at least one candidate target cell.

According to embodiments of the disclosure, the method further includes receiving a handover success message from the first node, wherein the handover success message includes information indicating that a user equipment has handed over and/or accessed to the first node.

According to embodiments of the disclosure, the method further includes receiving updated handover related information from a third node, and transmitting a radio resource control reconfiguration message to the user equipment, wherein the radio resource control reconfiguration message includes the updated handover related information.

According to embodiments of the disclosure, candidate target cells included in the second message include one or more of the following all candidate target cells of all candidate target nodes, all candidate target cells except cells of the first node, all candidate target cells of partial candidate target nodes, partial candidate target cells of partial candidate target nodes, and candidate target cells having an interface with a node to which the user equipment is currently connected.

According to embodiments of the disclosure, the method further includes making a handover decision based on the updated handover related information.

Embodiments of the disclosure provide a first node device in a wireless communication system, including a transceiver configured to transmit and receive signals, and a processor coupled to the transceiver and configured to perform any method performed by a first node in a wireless communication system according to embodiments of the disclosure.

Embodiments of the disclosure provide a second node device in a wireless communication system, including a transceiver configured to transmit and receive signals, and a processor coupled to the transceiver and configured to perform any method performed by a second node in a wireless communication system according to embodiments of the disclosure.

Embodiments of the disclosure provide a computer-readable medium having stored thereon computer-readable instructions which, when executed by a processor, implement methods performed by a first node and/or a second node and/or a user equipment in a wireless communication system according to embodiments of the disclosure.

The methods performed by the first node and/or the second node and/or the user equipment in the wireless communication system provided by the disclosure can ensure handover robustness and user performance by exchanging information related to handover between nodes.

In accordance with another aspect of the disclosure, one or more non-transitory computer-readable storage media storing computer-executable instructions that, when executed by one or more processors individually or collectively, cause a first node in a wireless communication system to perform operations are provided. The operations include receiving a fifth message from a second node, wherein the fifth message includes an L1/L2-triggered mobility (LTM) handover request, and wherein the fifth message includes information of at least one candidate target cell of the first node, transmitting a sixth message to the second node, wherein the sixth message includes an LTM handover request result, receiving a second message from the second node, wherein the second message includes information of at least one candidate target cell, transmitting a third message to a third node based on the information of the at least one candidate target cell, wherein the third message includes information indicating a user equipment to handover and/or access to the first node, and receiving a fourth message from the third node and/or the second node, wherein the fourth message includes updated handover related information.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features and advantages of certain embodiments of the disclosure will be more apparent from the following description taken in conjunction with the accompanying drawings, in which:

FIG. 1 is a system architecture of system architecture evolution (SAE) according to an embodiment of the disclosure;

FIG. 2 is a system architecture according to an embodiment of the disclosure;

FIGS. 3A, 3B, 3C, 3D, 3E, and 3F illustrate schematic diagrams of an aspect of a method for supporting handover between nodes according to various embodiments of the disclosure;

FIGS. 4A, 4B, 4C, 4D, 4E, and 4F illustrate schematic diagrams of an aspect of a method for supporting handover between nodes according to various embodiments of the disclosure;

FIGS. 5A, 5B, and 5C illustrate schematic diagrams of an aspect of a method for supporting handover between nodes according to various embodiments of the disclosure;

FIG. 6 illustrates a schematic diagram of an aspect of a method for supporting handover between nodes according to an embodiment of the disclosure;

FIG. 7 illustrates a flowchart of a method performed by a first node in a wireless communication system according to an embodiment of the disclosure;

FIG. 8 illustrates a flowchart of a method performed by a second node in a wireless communication system according to an embodiment of the disclosure;

FIG. 9 illustrates a schematic diagram of a first node according to an embodiment of the disclosure; and

FIG. 10 illustrates a schematic diagram of a second node according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms, such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

Figures discussed below and various embodiments for describing the principles of the disclosure in this patent document are only for illustration and should not be interpreted as limiting the scope of the disclosure in any way. Those skilled in the art will understand that the principles of the disclosure can be implemented in any suitably arranged system or device.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

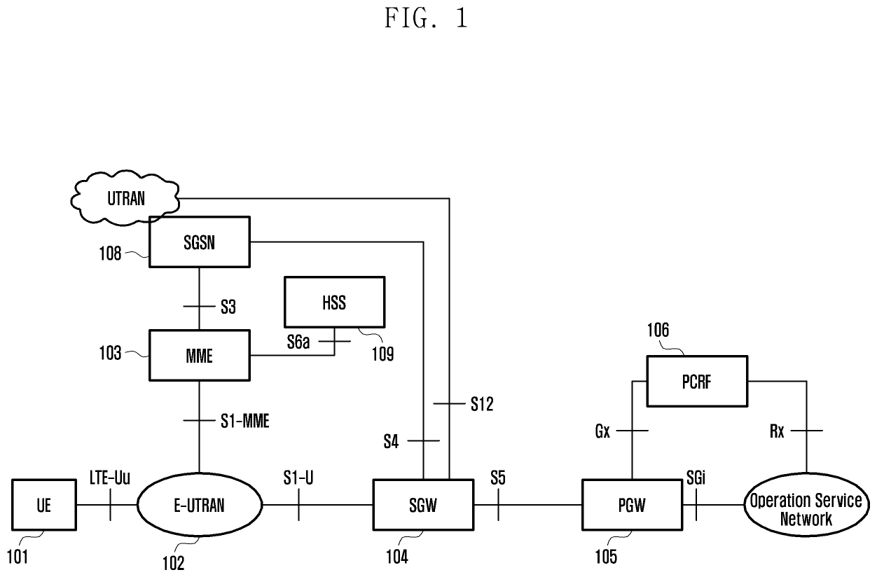

FIG. 1 is a system architecture 100 of system architecture evolution (SAE) according to an embodiment of the disclosure.

Referring to FIG. 1, a user equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, or the like, and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, or the like.

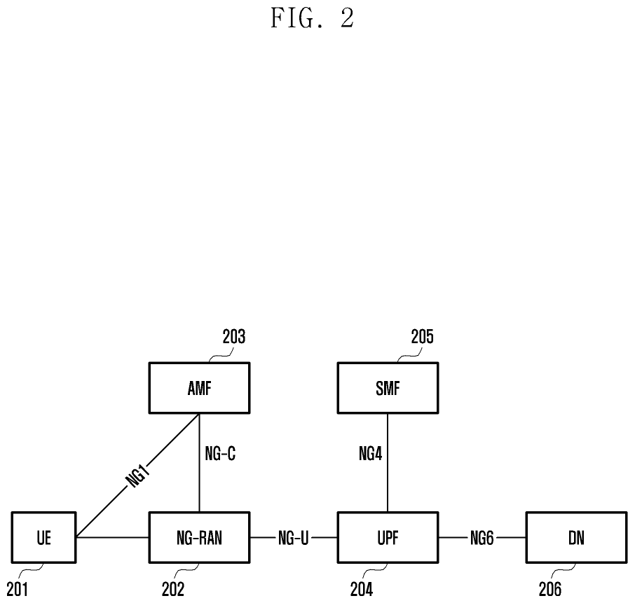

FIG. 2 is a system architecture 200 according to an embodiment of the disclosure. Other embodiments of the system architecture 200 can be used without departing from the scope of the disclosure.

Referring to FIG. 2, user equipment (UE) 201 is a terminal device for receiving data. A next generation radio access network (NG-RAN) 202 is a radio access network, which includes a base station (a gNB or an eNB connected to 5G core network 5 GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Entities and/or nodes mentioned in the disclosure may include gNB, gNB central unit (gNB-CU), gNB distributed unit (gNB-DU), gNB central unit control plane (gNB-CU-CP), gNB central unit user plane (gNB CU-UP), en-gNB, eNB, ng-eNB, UE, access and mobility management function (AMF), session management function (SMF), mobility management entity (MME) and other network entities or network logic units, and/or cells and/or beams managed by them, or the like.

The signal strength and/or signal quality described in the disclosure may be a received signal strength indicator (RSSI), a reference signal receiving power, RSRP), a reference signal receiving quality (RSRQ), and a signal to interference plus noise ratio (SINR), or the like.

The handover described in the disclosure may include one or more of the following: handover, secondary node addition, secondary node change, master node change, and the like.

In the disclosure, a node may refer to a node or a cell managed by the node. For example, a target node may refer to both a target node and a target cell.

In the disclosure, a cell may refer to a cell or a node where the cell is located.

In the disclosure, a source node may refer to a source node in any handover, such as handover of a source node, a source secondary node, or a source master node, or the like.

In the disclosure, a target node may also refer to a candidate target secondary node.

In the disclosure, a target node may refer to a target node in any handover, such as handover of a target node, a target secondary node, a target master node, a candidate target node, a candidate target secondary node, a candidate target master node, or the like.

In the disclosure, a target node may refer to one or more of the following: a target gNB CU, a target gNB DU, a target gNB CU-CP, a target gNB CU-UP, or the like.

In the disclosure, a source node may refer to one or more of the following: a source gNB CU, a source gNB DU, a source gNB CU-CP, a source gNB CU-UP, or the like.

In the disclosure, user equipment (UE) can also be used interchangeably with user, terminal, or the like.

In the disclosure, handover and Cell Switch may refer to each other.

In the disclosure, a handover command and a Cell Switch command may refer to each other.

Methods provided by the embodiments of the disclosure may also be called methods for supporting handover between nodes.

### Example 1

The disclosure provides a method for supporting handover between nodes, which may include:

a first node transmits a first message containing a request for information of a candidate target cell (for example, a candidate target cell for handover) to a second node, so that the second node can transmit relevant candidate target cell information to the first node, and the first node obtains information of (at least one) candidate target cell for making subsequent handover decisions. In some implementations, after the user accesses the first node, the first node has no relevant candidate target cell information, and the first node may request candidate target cell information from the source node (for example, it may be the second node), so that the first node can obtain candidate target cell information configured for the user, which provides information for the first node to make subsequent handover decisions.

In some implementations, the first message may be carried by one or more of the following messages: a HANDOVER SUCCESS message or a HANDOVER REQUEST ACKNOWLEDGE message or a RETRIEVE UE CONTEXT REQUEST message of Xn; or an ACCESS SUCCESS message of F1; or another and/or newly defined RRC and/or Xn and/or X2 and/or F1 and/or E1 and/or NG message and/or RRC container, or the like.

In some implementations, the first message may include one or more of the following fields or information:

UE identification (ID): used to identify a UE performing handover (or referred to as a UE related to handover). It may include one or more of the following: user ID assigned by a new node, user ID assigned by an old node, user ID assigned by a source node, user ID assigned by a (candidate) target node, user ID assigned by a source master node, user ID assigned by a source secondary node, user ID assigned by a (candidate) target master node, user ID assigned by a (candidate) target secondary node, user ID assigned by a first node, user ID assigned by a second node, user ID assigned by a transmitting node of the first message, user ID assigned by a receiving node of the first message, user ID assigned by a node triggering handover, user ID assigned by a node initially triggering handover, user ID assigned by a source node triggering handover, user ID assigned by a source node initially triggering handover, user ID assigned by a master node triggering handover, user ID assigned by a master node that triggered secondary node addition and/or change, user ID assigned by a handover (candidate) target node, user ID assigned by a node accessed by the UE, user ID assigned by a (candidate) target secondary node, user ID assigned by a secondary node accessed by the UE, or the like. The identification may be one ID, multiple IDs or a list of IDs. For example, the user ID may be a NG-RAN node UE XnAP ID. This information is used to identify the UE corresponding to the request of candidate target cells between nodes. This information may be used to identify and/or indicate the UE during information exchanging between (subsequent) candidate nodes.

Node ID: the node ID may be one or more of the following: node ID of a new node, node ID of an old node, node ID of a source node, node ID of a (candidate) target node, node ID of a source master node, node ID of a source secondary node, node ID of a (candidate) target master node, node ID of a (candidate) target secondary node, node ID of a first node, node ID of a second node, node ID of a transmitting node of the first message, node ID of a receiving node of the first message, node ID of a node triggering handover, node ID of a node initially triggering handover, node ID of a source node triggering handover, node ID of a source node initially triggering handover, node ID of a master node triggering handover, node ID of a master node triggering secondary node addition and/or change, node ID of a secondary node triggering handover, node ID of a secondary node triggering secondary node addition and/or change, node ID of a handover (candidate) target node, node ID of a node accessed by the UE, node ID of a (candidate) target secondary node, node ID of a secondary node accessed by the UE. This information is used to identify the UE corresponding to the request of candidate target cells between nodes. This information may be used to identify and/or indicate the UE during information exchanging between (subsequent) candidate nodes. In some implementations, for example, this ID may be used to identify and/or indicate the UE in combination with the above UE ID.

Request index: used to identify a request.

Identification for requesting to report candidate target cell information: used to indicate whether to request to report candidate target cell information. This identification may be identified by a single bit. For example, when this bit is 1, it means that reporting of candidate target cell information is requested, and when this bit is 0, it means that reporting of candidate target cell information is not requested. Alternatively, when this field appears, it indicates that reporting of candidate target cell information is requested, and when this field does not appear, it indicates that reporting of candidate target cell information is not requested.

Identification of a cell requested to report candidate target cell information: used to indicate the ID of a cell which is requested to report candidate target cell information. The identification may be one identification or a list of identifications. The cell identification may also be represented by combinations of one or more of the following: cell identification, node identification, beam identification, slice identification, or the like.

Scope of candidate target cells requested to report candidate target cell information: the scope may include information of candidate target cells (e.g., cell identification) and/or information of candidate target nodes (e.g., node identification) and/or slice information corresponding to candidate target cells (e.g., slice identification) corresponding to information that needs to be reported, and may also include information of candidate target cells (e.g., cell identification) and/or information of candidate target nodes (e.g., node identification) and/or slice information corresponding to candidate target cells (e.g., slice identification) corresponding to information that does not need to be reported. It may include the following situations:

(all) candidate target cells managed by all candidate target nodes (for example, all configured candidate target cells): in this case, the scope should include indication of candidate target cells managed by all candidate nodes, which is used to inform the receiving node of the message that information of all configured candidate target cells should be reported. This information may also be expressed by all configured candidate target cells, that is, the scope should include all configured candidate target cells.

All configured candidate target cells except candidate target cells managed by one or more certain nodes: in this case, the scope should include information (for example, node identification and/or cell identification) of one or more nodes and/or candidate target cells managed by the one or more nodes except candidate target cells managed by one or more certain nodes, and may also include information of candidate target cells (e.g., cell identification) and/or information of candidate target nodes (e.g., node identification) corresponding to information that needs to be reported, and may also include information of candidate target cells (e.g., cell identification) and/or information of candidate target nodes (e.g., node identification) corresponding to information that does not need to be reported. In some implementations, it may be all configured candidate target cells except the candidate target cells managed by the transmitting node of the first message.

(All) candidate target cells managed by partial candidate target nodes: in this case, the scope may include information of candidate target cells (e.g., cell identification) and/or information of candidate target nodes (e.g., node identification) corresponding to information that needs to be reported, and may also include information of candidate target cells (e.g., cell identification) and/or information of candidate target nodes (e.g., node identification) corresponding to information that does not need to be reported.

Partial candidate target cells managed by all candidate target nodes: the scope may include information of candidate target cells (e.g., cell identification) and/or information of candidate target nodes (e.g., node identification) corresponding to information that needs to be reported, and may also include information of candidate target cells (e.g., cell identification) and/or information of candidate target nodes (e.g., node identification) corresponding to information that does not need to be reported.

Partial candidate target cells managed by partial candidate target nodes: the scope may include information of candidate target cells (e.g., cell identification) and/or information of candidate target nodes (e.g., node identification) corresponding to information that needs to be reported, and may also include information of candidate target cells (e.g., cell identification) and/or information of candidate target nodes (e.g., node identification) corresponding to information that does not need to be reported.

Candidate target cell having an interface with a certain node: the scope may include information of the certain node, and indication of that the candidate target cell having an interface with the certain node needs to be reported, or the like. Herein, a certain node can generally refer to the certain node and/or a cell managed by the certain node. The information of a certain node may be the identification of the certain node and/or cell. In some implementations, the certain node may be the node to which the user is currently connected.

(Candidate) target cell information requested to be reported: used to indicate the candidate target cell information requested to be reported. The information may include one or more of the following: identification assigned by a candidate target node/cell to the user, identification assigned by a source node/cell to the user, identification assigned by a source node/cell to the user when the source node/cell exchanges information with the (candidate) target node/cell, source node identification, (candidate) target cell identification, identification of a node where the (candidate) target cell is located, identification of a beam corresponding to the (candidate) target cell, random access channel (RACH) resource configuration for obtaining timing advance (TA) in advance, RACH resource configuration, TA obtaining related information, reference signal configuration, reference configuration, number of radio bearers accepted by the (candidate) target cell, radio bearer information accepted by the (candidate) target cell, number of quality of service (QoS) flows accepted by the (candidate) target cell, QoS flow information accepted by the (candidate) target cell, transmission configuration indicator (TCI) information, channel state information (CSI) resource configuration information, CSI measurement configuration information, etc. The radio bearer may be a data radio bearer or a signaling radio bearer, or the like.

In some implementations, the second node transmits a second message containing candidate target cell information to the first node according to its own situation and/or the reception of a first message containing a request for candidate target cell information. After receiving this information, the first node can prepare and/or make subsequent handover decisions, such as selecting a handover target node, selecting an appropriate handover time, configuring the TA obtained in advance, and making a measurement configuration for the user, or the like. After receiving the candidate target cell information, the first node may also forward it to other nodes for other nodes to prepare and/or make subsequent handover decisions. Herein, the other nodes may be any nodes other than the second node. The candidate target cell may include all the cells managed by all candidate target nodes (for example, all the configured candidate target cells), all the configured candidate target cells except the cells managed by the first node, (all) the candidate target cells managed by partial candidate target nodes, partial candidate target cells managed by all candidate target nodes, partial candidate target cells managed by partial candidate target nodes, or candidate target cells having an interface with a certain node.

In some implementations, the second message may include or be carried by one or more of the following messages: a RETRIEVE UE CONTEXT RESPONSE message of Xn, or another and/or newly defined RRC and/or Xn and/or X2 and/or F1 and/or E1 and/or NG message and/or RRC container, or the like.

In some implementations, the second message may include one or more of the following fields or information:

UE identification (ID): used to identify a UE performing handover (or referred to as a UE related to handover). It may include one or more of the following: user ID assigned by a new node, user ID assigned by an old node, user ID assigned by a source node, user ID assigned by a (candidate) target node, user ID assigned by a source master node, user ID assigned by a source secondary node, user ID assigned by a (candidate) target master node, user ID assigned by a (candidate) target secondary node, user ID assigned by a first node, user ID assigned by a second node, user ID assigned by a transmitting node of the second message, user ID assigned by a receiving node of the second message, user ID assigned by a node triggering handover, user ID assigned by a node initially triggering handover, user ID assigned by a source node triggering handover, user ID assigned by a source node initially triggering handover, user ID assigned by a master node triggering handover, user ID assigned by a master node that triggered secondary node addition and/or change, user ID assigned by a handover (candidate) target node, user ID assigned by a node accessed by the UE, user ID assigned by a (candidate) target secondary node, user ID assigned by a secondary node accessed by the UE, or the like. The identification may be one ID, multiple IDs or a list of IDs. For example, the user ID may be a NG-RAN node UE XnAP ID. This information is used to identify the UE corresponding to the request of candidate target cells between nodes. This information may be used to identify and/or indicate the UE during information exchanging between (subsequent) candidate nodes.

Node ID: the node ID may be one or more of the following: node ID of a new node, node ID of an old node, node ID of a source node, node ID of a (candidate) target node, node ID of a source master node, node ID of a source secondary node, node ID of a (candidate) target master node, node ID of a (candidate) target secondary node, node ID of a first node, node ID of a second node, node ID of a transmitting node of the first message, node ID of a receiving node of the first message, node ID of a node triggering handover, node ID of a node initially triggering handover, node ID of a source node triggering handover, node ID of a source node initially triggering handover, node ID of a master node triggering handover, node ID of a master node triggering secondary node addition and/or change, node ID of a secondary node triggering handover, node ID of a secondary node triggering secondary node addition and/or change, node ID of a handover (candidate) target node, node ID of a node accessed by the UE, node ID of a (candidate) target secondary node, node ID of a secondary node accessed by the UE. This information may be used to identify and/or indicate the UE during information exchanging between (subsequent) candidate nodes. In some implementations, for example, this ID may be used to identify and/or indicate the UE in combination with the above UE ID.

Request index corresponding to the report: used to identify an index of the request corresponding to the report.

Reported candidate target cell information: used to indicate the reported candidate target cell information. The information may include one or more of the following: identification assigned by a (candidate) target node/cell to the user, identification assigned by a source node/cell to the user, identification assigned by a source node/cell to the user when the source node/cell exchanges information with the (candidate) target node/cell, source node identification, (candidate) target cell identification, identification of a node where the (candidate) target cell is located, identification of a beam corresponding to the (candidate) target cell, RACH resource configuration for obtaining Timing Advance (TA) in advance, RACH resource configuration, TA obtaining related information, reference signal configuration, reference configuration, number of radio bearers accepted by the (candidate) target cell, radio bearer information accepted by the (candidate) target cell, number of quality of service (QoS) flows accepted by the (candidate) target cell, QoS flow information accepted by the (candidate) target cell, transmission configuration indicator (TCI) information, channel state information (CSI) resource configuration information, CSI measurement configuration information, or the like. The radio bearer may be a data radio bearer or a signaling radio bearer, or the like.

In some implementations, for example, the first node may be a node newly accessed and/or handed over to by the user, and the second node may be a node originally accessed by the user and/or a source node in handover. For example, the first node can make subsequent handover decisions according to the candidate target cell information obtained from the second node, for example, make a subsequent LTM handover decision, or make a subsequent CPAC decision.

In other implementations, for example, the first node may be a master node, and the second node may be a secondary node originally accessed by the user and/or a source secondary node in handover. For example, the master node can obtain the candidate target cell information configured by the source secondary node for handover decision and/or subsequent handover decision. Alternatively, the master node can forward it to a candidate target node for the candidate target node to prepare and/or set the configuration and/or resources related to the subsequent handover.

In still other implementations, the first node may be a secondary node newly accessed and/or handed over to by the user, and the second node may be a master node. For example, the first node can make subsequent handover decisions according to the candidate target cell information obtained from the second node, for example, make a subsequent LTM handover decision, or make a subsequent CPAC decision.

In still other implementations, the first node may be a secondary node accessed and/or handed over to by the user, and the second node may be a secondary node before the handover. For example, the first node can make subsequent handover decisions according to the candidate target cell information obtained from the second node, for example, make a subsequent LTM handover decision, or make a subsequent CPAC decision.

In still other implementations, the first node may be a source node in handover and the second node may be a (candidate) target node in handover. For example, the first node may make a handover decision based on the information of the candidate target cell obtained from the second node, and/or trigger the user to perform handover, and/or trigger the user to obtain TA, or the like.

In still other implementations, the first node may be a node accessed and/or handed over to by the user, and the second node may be a (candidate) target node in handover. For example, the first node can make subsequent handover decisions according to the candidate target cell information obtained from the second node, for example, make a subsequent LTM handover decision, or make a subsequent CPAC decision.

Since a user is uniquely identified by identification (ID) between the candidate target node/cell and the source node/cell, the user cannot be uniquely identified by the identification assigned by the candidate target node/cell and/or the source node/cell between the candidate target nodes/cells. For example, when candidate target nodes exchange information with each other, there is no relevant identification to uniquely identify a user. In some implementations, for example, after a user is handed over to a candidate target cell, the candidate target cell becomes the user's accessing cell, and the node where the candidate target cell is located becomes the user's accessing node. When the user's accessing node exchanges information with the candidate target node, there is no relevant identification to uniquely identify the user. After the user is handed over to a candidate target cell, the candidate target cell becomes the user's accessing cell, and the node where the candidate target cell is located becomes the user's accessing node, so the identification assigned by other candidate target cells to the user and/or the identification assigned by a source node/cell to the user when the source node/cell exchanges information with other candidate target node/cells and/or the node ID of a source node in the above messages, and/or the UE ID in the first message or the second message, and/or the node ID in the first message or the second message, can be used to inform other candidate target nodes and/or cells of the user for which a handover related message is targeted when the user's accessing node transmits the handover related message to other candidate target nodes and/or cells. Specifically, a user can be uniquely identified between a source node/cell and a candidate target node/cell A by the identification (for example, identification 1) assigned by the source node/cell and/or the identification (for example, identification A) assigned by the candidate target node/cell A, and a user can also be uniquely identified between the source node/cell and a candidate target node/cell B by the identification (for example, identification 2, where identification 1 may be the same as or different from identification 2) assigned by the source node/cell and/or the identification (for example, identification B) assigned by the candidate target node/cell B. When the candidate target node/cell A exchanges information with another candidate target nodes/cell (here, candidate target node/cell B is taken as an example), it needs to use the identification (for example, identification B) assigned by the candidate target node/cell B to the user, and/or the identification (for example, identification 2) assigned by the source node/cell to the user when the source node/cell exchanges information with the candidate target node/cell B, and/or the identification of the source node, and/or the UE identification in the first message or the second message, and/or the node identification in the first message or the second message, to inform the candidate target node/cell B of the user corresponding to the transmitted message. In some implementations, for example, after the user is handed over to the candidate target cell A, the candidate target cell A becomes the user's accessing cell, and the node A where the candidate target cell is located becomes the user's accessing node. When the user's accessing node/cell (i.e., the aforementioned candidate target node/cell A) exchanges information with another candidate target nodes/cell (here, the candidate target node/cell B is taken as an example), it needs to use the identification (e.g., identification B) assigned by the candidate target node/cell B to the user, and/or the identification assigned by the source node/cell to the user when the source node/cell exchanges information with the candidate target node/cell B, and/or the identification of the source node, and/or the UE identification in the first message or the second message, and/or the node identification in the first message or the second message, to inform the candidate target node/cell B of the user corresponding to the transmitted message. Therefore, the exchanged candidate target cell information needs to include the identification assigned by the candidate target node/cell to the user, and/or the identification assigned by the source node/cell to the user, and/or the identification assigned by the source node/cell to the user when the source node/cell exchanges information with the candidate target node/cell, and/or the identification of the source node, and/or the UE identification in the first message or the second message, and/or the node identification in the first message or the second message. In this way, the user corresponding to the candidate target node/cell information can be determined (by a receiving node of the candidate target node/cell information) when the receiving node of the candidate target node/cell information exchanges information with other candidate target nodes/cells. In the case of dual-connectivity, the source node/cell described above may be a master node/cell, and the candidate target node/cell described above may be a candidate target secondary node/cell. In some implementations, for example, the source node may be the source node that (initially) triggers the handover, and may also be the master node that initially triggers secondary node addition and/or change.

### Example 2

The disclosure provides a method for supporting handover between nodes, which may include:

a third node transmits a third message to a fourth node, which contains information indicating a user's handover and/or access to a (or specific) node, so that the fourth node can know the information of the user's handover and/or access to a node. In some implementations, for example, the fourth node can transmit handover related information to the node that the user is handed over and/or accessed to. In some implementations, for example, the handover related information may include handover configuration information, TA obtaining related information, and the like. In some implementations, for example, the handover related information (e.g., handover configuration information and/or TA obtaining related information, or the like) may be handover configuration update information described below, and may be transmitted by using the fourth message described below.

In some implementations, the third message may include or be carried by one or more of the following messages: a HANDOVER SUCCESS message of Xn; or an ACCESS SUCCESS message of F1; or another and/or newly defined RRC and/or Xn and/or X2 and/or F1 and/or E1 and/or NG message and/or RRC container, or the like.

In some implementations, the third message may include one or more of the following fields or information:

User ID: used to identify a UE for handover (or referred to as UE related to handover). It may include one or more of the following: user ID assigned by an old source node, identification assigned by an old source node/cell to the user when the old source node/cell exchanges information with the candidate target node/cell, identification assigned by an old source node/cell to the user when the old source node/cell exchanges information with a receiving node of the third message, user ID assigned by a source node, user ID assigned by a (candidate) target node, user ID assigned by a source master node, user ID assigned by a source secondary node, user ID assigned by a (candidate) target master node, user ID assigned by a (candidate) target secondary node, user ID assigned by an accessing node, user ID assigned by a new node, user ID assigned by an old node, user ID assigned by a source node, user ID assigned by a target node, user ID assigned by a master node, user ID assigned by a secondary node, user ID assigned by a transmitting node of the third message, user ID assigned by a receiving node of the third message, user ID assigned by a node triggering handover, user ID assigned by a node initially triggering handover, user ID assigned by a source node triggering handover, user ID assigned by a source node initially triggering handover, user ID assigned by a master node triggering handover, user ID assigned by a master node that triggered secondary node addition and/or change, user ID assigned by a handover (candidate) target node, user ID assigned by a node accessed by the UE, user ID assigned by a (candidate) target secondary node, user ID assigned by a secondary node accessed by the UE, or the like. The identification may be one ID, multiple IDs or a list of IDs. For example, the user ID may be a NG-RAN node UE XnAP ID. This information is used to identify the UE corresponding to the exchanged information between nodes.

Node ID: the node ID may be one or more of the following: node ID of a new node, node ID of an old node, node ID of a source node, node ID of a (candidate) target node, node ID of a source master node, node ID of a source secondary node, node ID of a (candidate) target master node, node ID of a (candidate) target secondary node, node ID of a first node, node ID of a second node, node ID of a transmitting node of the first message, node ID of a receiving node of the first message, node ID of a node triggering handover, node ID of a node initially triggering handover, node ID of a source node triggering handover, node ID of a source node initially triggering handover, node ID of a master node triggering handover, node ID of a master node triggering secondary node addition and/or change, node ID of a secondary node triggering handover, node ID of a secondary node triggering secondary node addition and/or change, node ID of a handover (candidate) target node, node ID of a node accessed by the UE, node ID of a (candidate) target secondary node, node ID of a secondary node accessed by the UE. This information is used to identify the UE corresponding to the exchanged information between nodes. In some implementations, for example, this ID may be used to identify and/or indicate the UE in combination with the above UE ID.

ID of the target cell accessed by the user: used to indicate the ID of the cell accessed by the user.

ID of the target node accessed by the user: used to indicate the ID of the node accessed by the user. The node ID may include one or more of the following: NG-RAN node ID, gNB DU ID, gNB CU ID, or the like.

In some implementations, for example, the third node may be a node newly accessed and/or handed over to by the user, and the fourth node may be another candidate target node.

In other implementations, for example, the third node may be a master node and the fourth node may be another candidate target secondary node.

In still other implementations, the third node may be a secondary node newly accessed and/or handed over to by the user, and the fourth node may be a master node.

Since a user is uniquely identified by identification (ID) between the candidate target node/cell and the source node/cell, the user cannot be uniquely identified by the identification assigned by the candidate target node/cell and/or the source node/cell between the candidate target nodes/cells. For example, when candidate target nodes exchange information with each other, there is no relevant identification to uniquely identify a user. In some implementations, for example, after a user is handed over to a candidate target cell, the candidate target cell becomes the user's accessing cell, and the node where the candidate target cell is located becomes the user's accessing node. When the user's accessing node exchanges information with the candidate target node, there is no relevant identification to uniquely identify the user. After the user is handed over to a candidate target cell, the candidate target cell becomes the user's accessing cell, and the node where the candidate target cell is located becomes the user's accessing node, so the identification assigned by other candidate target nodes/cells to the user and/or the identification assigned by a source node/cell to the user when the source node/cell exchanges information with other candidate target node/cells and/or the node ID of a source node in the above messages, and/or the UE ID in the third message, and/or the node ID in the third message, can be used to inform other candidate target nodes and/or cells of the user for which a handover related message is targeted when the user's accessing node transmits the handover related message to other candidate target nodes and/or cells. Specifically, a user can be uniquely identified between a source node/cell and a candidate target node/cell A by the identification (for example, identification 1) assigned by the source node/cell and/or the identification (for example, identification A) assigned by the candidate target node/cell A, and a user can also be uniquely identified between the source node/cell and a candidate target node/cell B by the identification (for example, identification 2, where identification 1 may be the same as or different from identification 2) assigned by the source node/cell and/or the identification (for example, identification B) assigned by the candidate target node/cell B. When the candidate target node/cell A exchanges information with another candidate target nodes/cell (here, candidate target node/cell B is taken as an example), it needs to use the identification (for example, identification B) assigned by the candidate target node/cell B to the user, and/or the identification (for example, identification 2) assigned by the source node/cell to the user when the source node/cell exchanges information with the candidate target node/cell B, and/or the identification of the source node, and/or the UE identification in the third message, and/or the node identification in the third message, to inform the candidate target node/cell B of the user corresponding to the transmitted message. In some implementations, for example, after the user is handed over to the candidate target cell A, the candidate target cell A becomes the user's accessing cell, and the node A where the candidate target cell is located becomes the user's accessing node. When the user's accessing node/cell (i.e., the aforementioned candidate target node/cell A) exchanges information with another candidate target nodes/cell (here, the candidate target node/cell B is taken as an example), it needs to use the identification (e.g., identification B) assigned by the candidate target node/cell B to the user, and/or the identification assigned by the source node/cell to the user when the source node/cell exchanges information with the candidate target node/cell B, and/or the identification of the source node, and/or the UE identification in the third message, and/or the node identification in the third message, to inform the candidate target node/cell B of the user corresponding to the transmitted message. Therefore, the third message needs to include one or more of the user identifications, for example, It may be user ID assigned by an old source node, identification assigned by an old source node/cell to the user when the old source node/cell exchanges information with the candidate target node/cell, identification assigned by an old source node/cell to the user when the old source node/cell exchanges information with a receiving node of the third message, user ID assigned by a source node, user ID assigned by a (candidate) target node, user ID assigned by a source master node, user ID assigned by a source secondary node, user ID assigned by a (candidate) target master node, user ID assigned by a (candidate) target secondary node, user ID assigned by an accessing node, user ID assigned by a new node, user ID assigned by an old node, user ID assigned by a source node, user ID assigned by a target node, user ID assigned by a master node, user ID assigned by a secondary node, user ID assigned by a transmitting node of the third message, user ID assigned by a receiving node of the third message, user ID assigned by a node triggering handover, user ID assigned by a node initially triggering handover, user ID assigned by a source node triggering handover, user ID assigned by a source node initially triggering handover, user ID assigned by a master node triggering handover, user ID assigned by a master node that triggered secondary node addition and/or change, user ID assigned by a handover (candidate) target node, user ID assigned by a node accessed by the UE, user ID assigned by a (candidate) target secondary node, and user ID assigned by a secondary node accessed by the UE, or the like, to inform the receiving node of the third message and/or the candidate target node of the user for which the transmitted message is targeted.

### Example 3

The disclosure provides a method for supporting handover between nodes, which may include:

a fifth node transmits a fourth message to a sixth node, which contains handover configuration updated information (for example, of the candidate target cells) (which can also be called updated handover configuration information or updated handover related information herein), so that the sixth node can know the latest handover configuration information, and the sixth node can use this message to make handover decision, or forward this message to other nodes for other nodes to make handover decision for corresponding user equipment. In some implementations, for example, in the case of conditional handover and/or L1/L2-triggered mobility (LTM), after the handover request is made, the user will not hand over to a target node immediately, and the configuration of the node may change, so the (candidate) target node (e.g., the fifth node) may transmit handover configuration updated information to the source node (e.g., the sixth node). The update may include update and/or modification, addition, cancellation, or the like. In some implementations, for example, if a configuration is cancelled, the corresponding cell may not continue to be the (candidate) target cell.

In some implementations, the fourth message may include or be carried by one or more of the following messages: a UE CONTEXT SETUP REQUEST message or a UE CONTEXT SETUP RESPONSE message or a UE CONTEXT MODIFICATION REQUEST message or a UE CONTEXT MODIFICATION RESPONSE message of F1; or a HANDOVER REQUEST message or a RETRIEVE UE CONTEXT RESPONSE message or a RETRIEVE UE CONTEXT FAILURE message of X2 or Xn; or a SENB ADDITION REQUEST message or a SGNB ADDITION REQUEST message of X2; or an S-NODE ADDITION REQUEST message or an S-NODE ADDITION REQUEST ACKNOWLEDGE message or an S-NODE MODIFICATION REQUIRED message or an S-NODE MODIFICATION CONFIRM message or an S-NODE CHANGE REQUIRED message or an S-NODE CHANGE CONFIRM message or an S-NODE MODIFICATION REQUEST message or an S-NODE MODIFICATION REQUEST ACKNOWLEDGE message of Xn; or another and/or newly defined RRC and/or Xn and/or X2 and/or F1 and/or E1 and/or NG message.

In some implementations, the fourth message may include one or more of the following fields or information:

User ID: used to identify a UE for handover (or referred to as UE related to handover). It may include one or more of the following: user ID assigned by a new node, user ID assigned by an old node, user ID assigned by a source node, user ID assigned by a (candidate) target node, user ID assigned by a master node, user ID assigned by a secondary node, user ID assigned by a source master node, user ID assigned by a source secondary node, user ID assigned by a (candidate) target master node, user ID assigned by a (candidate) target secondary node, user ID assigned by a transmitting node of the fourth message, user ID assigned by a receiving node of the fourth message, user ID assigned by a node triggering handover, user ID assigned by a node initially triggering handover, user ID assigned by a source node triggering handover, user ID assigned by a source node initially triggering handover, user ID assigned by a master node triggering handover, user ID assigned by a master node that triggered secondary node addition and/or change, user ID assigned by a handover (candidate) target node, user ID assigned by a node accessed by the UE, user ID assigned by a (candidate) target secondary node, user ID assigned by a secondary node accessed by the UE, or the like. The identification may be one ID, multiple IDs or a list of IDs. For example, the user ID may be a NG-RAN node UE XnAP ID. This information is used to identify the UE corresponding to the exchanged information between nodes.

Node ID: the node ID may be one or more of the following: node ID of a new node, node ID of an old node, node ID of a source node, node ID of a (candidate) target node, node ID of a source master node, node ID of a source secondary node, node ID of a (candidate) target master node, node ID of a (candidate) target secondary node, node ID of a first node, node ID of a second node, node ID of a transmitting node of the first message, node ID of a receiving node of the first message, node ID of a node triggering handover, node ID of a node initially triggering handover, node ID of a source node triggering handover, node ID of a source node initially triggering handover, node ID of a master node triggering handover, node ID of a master node triggering secondary node addition and/or change, node ID of a secondary node triggering handover, node ID of a secondary node triggering secondary node addition and/or change, node ID of a handover (candidate) target node, node ID of a node accessed by the UE, node ID of a (candidate) target secondary node, node ID of a secondary node accessed by the UE. This information is used to identify the UE corresponding to the exchanged information between nodes. In some implementations, for example, this ID may be used to identify and/or indicate the UE in combination with the above UE ID.

Updated and/or modified configuration related information:

Target cell ID: used to identify the ID of the target cell corresponding to the updated configuration.

Target node ID: used to identify the ID of the target node corresponding to the updated configuration.

Updated and/or modified configuration parameters, which may include one or more of the following: identification assigned by a candidate target cell to the user, identification assigned by a source cell to the user, identification assigned by a source cell to the user when the source cell exchanges information with a candidate target cell, the corresponding beam identification in the candidate target cell, RACH resource configuration for obtaining timing advance (TA) in advance, RACH resource configuration, TA obtaining related information, reference signal configuration, reference configuration, number of radio bearers accepted by the candidate target cell, radio bearer information accepted by the candidate target cell, number of quality of service (QoS) flows accepted by candidate target cell, QoS flow information accepted by the candidate target cell, transmission configuration indicator (TCI) information, channel state information (CSI) resource configuration information, CSI measurement configuration information, or the like. The radio bearer may be a data radio bearer or a signaling radio bearer, or the like.

Cancelled configuration related information:

Target cell ID: used to identify the ID of the target cell corresponding to the cancelled configuration, or it may be a cancelled target cell ID.

Target node ID: used to identify the ID of the target node corresponding to the cancelled configuration, or it may be a cancelled target node ID.

Cancelled configuration parameters, which may include one or more of the following: identification assigned by a candidate target cell to the user, identification assigned by a source cell to the user, identification assigned by a source cell to the user when the source cell exchanges information with a candidate target cell, the corresponding beam identification in the candidate target cell, RACH resource configuration for obtaining timing advance (TA) in advance, RACH resource configuration, TA obtaining related information, reference signal configuration, reference configuration, number of radio bearers accepted by the candidate target cell, radio bearer information accepted by the candidate target cell, number of quality of service (QoS) flows accepted by candidate target cell, QoS flow information accepted by the candidate target cell, or the like. The radio bearer may be a data radio bearer, a signaling radio bearer, transmission configuration indicator (TCI) information, channel state information (CSI) resource configuration information, CSI measurement configuration information, etc.

Added configuration related information:

Target cell ID: used to identify the ID of the target cell corresponding to the newly added configuration, or it may be a newly added target cell ID.

Target node ID: used to identify the ID of the target node corresponding to the newly added configuration, or it may be a newly added target node ID.

Newly added configuration parameters, which may include one or more of the following: identification assigned by a candidate target cell to the user, identification assigned by a source cell to the user, identification assigned by a source cell to the user when the source cell exchanges information with a candidate target cell, the corresponding beam identification in the candidate target cell, RACH resource configuration for obtaining timing advance (TA) in advance, RACH resource configuration, TA obtaining related information, reference signal configuration, reference configuration, number of radio bearers accepted by the candidate target cell, radio bearer information accepted by the candidate target cell, number of quality of service (QoS) flows accepted by candidate target cell, QoS flow information accepted by the candidate target cell, or the like. The radio bearer may be a data radio bearer, a signaling radio bearer, transmission configuration indicator (TCI) information, channel state information (CSI) resource configuration information, CSI measurement configuration information, or the like.

Valid/effective time of configuration: within the valid time, the configuration is valid/effective; and the configuration is not valid/effective outside the valid time. This information can enable the target node for handover to reserve resources for a certain period of time, and avoid the waste of resources caused by long-term resource reservation for handover. Especially in the case of resource shortage, long-term resource reservation may lead to performance damage of other users due to resource shortage.

TA obtaining related information: For example, it may include an obtained TA value and/or related parameters used for calculating the TA value. The information may include one or more of the following: TA value, valid time of TA, time offset, drift rate of a TA value, drift rate variation of a TA value, transmission and reception point (TRP) reception time of an uplink subframe containing a physical random access channel (PRACH) transmitted by the UE, TRP transmission time of a downlink subframe closest in time to the subframe received from the UE, preamble, preamble index, system frame number (SFN), synchronization signal block (SSB) index, RACH occasion (RO), RACH resource configuration, and RACH resource configuration for obtaining timing advance (TA) in advance. Herein, the TA value may include one or more of the following: time advance, time offset, or the like. The TA obtaining related information may be used for subsequently transmit the obtained TA value to a corresponding user, so that the corresponding user can synchronize with the handover target node. The information may be used for the receiving node of the information to determine that the obtained TA value is for the corresponding user, and/or to inform the receiving node of the corresponding TA value.

### Example 4

The disclosure provides a method for supporting handover between nodes, which may include:

a seventh node transmits a fifth message containing an LTM handover request to an eighth node, so that the eighth node can obtain information related to an LTM request, which is used for the eighth node and/or other nodes to determine whether to accept the LTM handover request.

In some implementations, the fifth message may include or be carried by one or more of the following messages: a HANDOVER REQUEST message or a RETRIEVE UE CONTEXT RESPONSE message or a RETRIEVE UE CONTEXT FAILURE message of X2 or Xn; or a SENB ADDITION REQUEST message or a SGNB ADDITION REQUEST message of X2; or an S-NODE ADDITION REQUEST message or an S-NODE ADDITION REQUEST ACKNOWLEDGE message or an S-NODE MODIFICATION REQUIRED message or an S-NODE MODIFICATION CONFIRM message or an S-NODE CHANGE REQUIRED message or an S-NODE CHANGE CONFIRM message or an S-NODE MODIFICATION REQUEST message or an S-NODE MODIFICATION REQUEST ACKNOWLEDGE message of Xn; a UE CONTEXT SETUP REQUEST message or a UE CONTEXT SETUP RESPONSE message or a UE CONTEXT MODIFICATION REQUEST message or a UE CONTEXT MODIFICATION RESPONSE message of F1; or another and/or newly defined RRC and/or Xn and/or X2 and/or F1 and/or E1 and/or NG message.

In some implementations, the fifth message may include one or more of the following fields or information:

User ID: used to identify a UE for handover (or referred to as UE related to handover). It may include one or more of the following: user ID assigned by a new node, user ID assigned by an old node, user ID assigned by a source node, user ID assigned by a target node, user ID assigned by a master node, user ID assigned by a secondary node, user ID assigned by a transmitting node of the fifth message, user ID assigned by a receiving node of the fifth message, or the like. The identification may be one ID, multiple IDs or a list of IDs. For example, the user ID may be a NG-RAN node UE XnAP ID. This information is used to identify the UE corresponding to the exchanged information between nodes.

Node ID: the node ID may be one or more of the following: node ID of a new node, node ID of an old node, node ID of a source node, node ID of a (candidate) target node, node ID of a source master node, node ID of a source secondary node, node ID of a (candidate) target master node, node ID of a (candidate) target secondary node, node ID of a first node, node ID of a second node, node ID of a transmitting node of the first message, node ID of a receiving node of the first message, node ID of a node triggering handover, node ID of a node initially triggering handover, node ID of a source node triggering handover, node ID of a source node initially triggering handover, node ID of a master node triggering handover, node ID of a master node triggering secondary node addition and/or change, node ID of a secondary node triggering handover, node ID of a secondary node triggering secondary node addition and/or change, node ID of a handover (candidate) target node, node ID of a node accessed by the UE, node ID of a (candidate) target secondary node, node ID of a secondary node accessed by the UE. This information is used to identify the UE corresponding to the exchanged information between nodes. In some implementations, for example, this ID may be used to identify and/or indicate the UE in combination with the above UE ID.

Target cell ID: the target cell ID may be one cell ID or multiple cell IDs. When the target cell ID is multiple cell IDs, multiple cells can be requested to serve as the target cells of the handover user by one request message, thus avoiding transmitting multiple messages to the same target node (for example, each message requests one target cell) to achieve an effect of signaling saving.

Target node ID: used to indicate the identification of the target node where the target cell is located.

LTM handover identification: used to indicate that the request is for LTM handover. In the case of handover of LTM, the target node needs to reserve resources for a long time to ensure the subsequent handover of LTM. Herein, for a subsequent handover of LTM, the UE can reserve the configuration as the configuration for the subsequent handover of LTM after handover. Therefore, the target node can receive and/or reject the LTM handover request based on its own situation. For example, when resources are limited and/or the load is heavy, it can reject the LTM handover request, so as to avoid the performance damage of other users due to resource shortage caused by the target node reserving resources for LTM for a long time, so as to improve resource utilization.

Request for RACH resource configuration for obtaining Timing Advance (TA) in advance: which indicates that it is requested to report the RACH resource configuration for obtaining TA in advance.

Reference signal configuration request: which indicates that it is requested to report the reference signal configuration.

Reference Configuration: if this field is included in the fifth message, the receiving node performs configuration settings based on this reference configuration.

In some implementations, based on the received fifth message containing the LTM handover request, the eighth node transmits a sixth message containing an LTM handover request result to the seventh node if the eighth node can accept and/or partially accept the LTM handover request. If the eighth node can not accept the LTM handover request, the eighth node transmits a sixth message including relevant information of not accepting the request to the seventh node as a message that the LTM handover request failed, so that the seventh node can continue to select other cells as target cells for the subsequent handover process.

In some implementations, the sixth message may include or be carried by one or more of the following messages: a HANDOVER REQUEST ACKNOWLEDGE message or a RETRIEVE UE CONTEXT REQUEST message or a HANDOVER SUCCESS message of X2 or Xn; or a SENB ADDITION REQUEST ACKNOWLEDGE message or a SGNB ADDITION REQUEST ACKNOWLEDGE message of X2; or an S-NODE ADDITION REQUEST ACKNOWLEDGE message of Xn; or a UE CONTEXT SETUP REQUEST message or a UE CONTEXT SETUP RESPONSE message or a UE CONTEXT MODIFICATION REQUEST message or a UE CONTEXT MODIFICATION RESPONSE message or an ACCESS SUCCESS message of F1; or another and/or newly defined RRC and/or Xn and/or X2 and/or F1 and/or E1 and/or NG message.

In some implementations, the sixth message may include one or more of the following fields or information:

User ID: used to identify a UE for handover (or referred to as UE related to handover). It may include one or more of the following: user ID assigned by a new node, user ID assigned by an old node, user ID assigned by a source node, user ID assigned by a target node, user ID assigned by a master node, user ID assigned by a secondary node, user ID assigned by a transmitting node of the sixth message, user ID assigned by a receiving node of the sixth message, or the like. The identification may be one ID, multiple IDs or a list of IDs. For example, the user ID may be a NG-RAN node UE XnAP ID. This information is used to identify the UE corresponding to the exchanged information between nodes.

Node ID: the node ID may be one or more of the following: node ID of a new node, node ID of an old node, node ID of a source node, node ID of a (candidate) target node, node ID of a source master node, node ID of a source secondary node, node ID of a (candidate) target master node, node ID of a (candidate) target secondary node, node ID of a first node, node ID of a second node, node ID of a transmitting node of the first message, node ID of a receiving node of the first message, node ID of a node triggering handover, node ID of a node initially triggering handover, node ID of a source node triggering handover, node ID of a source node initially triggering handover, node ID of a master node triggering handover, node ID of a master node triggering secondary node addition and/or change, node ID of a secondary node triggering handover, node ID of a secondary node triggering secondary node addition and/or change, node ID of a handover (candidate) target node, node ID of a node accessed by the UE, node ID of a (candidate) target secondary node, node ID of a secondary node accessed by the UE. This information is used to identify the UE corresponding to the exchanged information between nodes. In some implementations, for example, this ID may be used to identify and/or indicate the UE in combination with the above UE ID.

IDs of accepted target cells: the target cell IDs may be one cell ID or multiple cell IDs. If all the requested target cells are accepted, IDs of all the accepted cells can be included, or a special indication can be used to indicate “all accepted”. If they are partially accepted, IDs of accepted cells can be included, or, IDs of cells that are not accepted can be included in the IDs of unaccepted target cells below.

Information corresponding to accepted target cells: this information may include one or more of the following: identification assigned by a (candidate) target node/cell to the user, identification assigned by a source node/cell to the user, identification assigned by a source node/cell to the user when the source node/cell exchanges information with the (candidate) target node/cell, source node identification, (candidate) target cell identification, identification of a node where the (candidate) target cell is located, identification of a beam corresponding to the (candidate) target cell, RACH resource configuration for obtaining timing advance (TA) in advance, RACH resource configuration, TA obtaining related information, reference signal configuration, reference configuration, number of radio bearers accepted by the (candidate) target cell, radio bearer information accepted by the (candidate) target cell, number of quality of service (QoS) flows accepted by the (candidate) target cell, QoS Flow information accepted by the (candidate) target cell, transmission configuration indicator (TCI) information, channel state information (CSI) resource configuration information, CSI measurement configuration information, or the like. The radio bearer may be a data radio bearer or a signaling radio bearer, or the like.

RACH resource configuration for obtaining timing advance (TA) in advance: indicates RACH resource configuration for obtaining TA in advance.

Reference signal configuration: used to indicate the reference signal transmission configuration of the target node. This information may be used by the accessing node of UE to set measurement configuration for the user.

Target node configuration: used to indicate configuration of a target node for the handover.

Reference configuration corresponding to the target node configuration: used to indicate which reference configuration the target node configuration is set for.

Identification of unaccepted target cells: indicates the IDs of unaccepted target cells. The target cell identification may be one cell ID or multiple cell IDs.

Reasons for non-acceptance: indicates the reasons why the target cells and/or the LTM handover request can not be accepted. It may include one or more of the following: the target cell is overloaded, the target cell is in an energy-saving mode, the target cell cannot reserve resources for a long time, the target cell cannot accept the handover request of LTM, the target cell can only accept normal handover, and the target cell cannot accept the minimization of drive tests (MDT) measurement configuration, or the like. This information can inform the handover requesting node of reasons for non-acceptance, so that the handover requesting node can adjust the handover request according to the reasons, and can also select other cells as the handover target cells. For example, if the reason for non-acceptance is that an LTM handover request cannot be accepted, the handover requesting node may continue to take the cell as the target cell for normal handover (e.g., non-LTM handover).

In the disclosure, estimation and prediction may refer to each other.

In the disclosure, credibility, confidence and accuracy may refer to each other.

In the disclosure, handover related decisions and/or handover decisions may include one or more of the following: whether to trigger handover, selection of target cells and/or nodes, selection of handover time, whether to add secondary nodes, whether to change secondary nodes, resource reservation, resource release, decide whether to perform early data forwarding, decide when to perform early data forwarding, perform early data forwarding, and perform data transmission, or the like.

In the disclosure, time may be represented by one or more of the following: timestamp, time point, time interval, timer, period of time, time length, time period/periodicity, time spacing, or the like. Herein, the time length may be a length of time from a certain time point, which may be the current time. The time may be a relative time or an absolute time. In an implementation, a period of time may be represented by separate fields, for example, by a combination of a start time and an end time, or by a combination of a start time and a time period.

In the disclosure, RACH resource configuration may include one or more of the following:

Feature combination: used to indicate the features applicable to the configuration. The features may include one or more of the following: RedCap, SDT (or smallData), slice (or slice group), coverage enhancement, or the like.

Start preamble for a partition (startPreambleForThisPartition).

Number of Preambles for a partition (numberOfPreamblesForThisPartition).

Mask indexes of RACH Occasions (ROs) shared by synchronization signal block (SSB) for a partion (ssb-SharedRO-Masklndex).

Number of consecutive preambles belonging to GroupA (numberOfRA-PreamblesGroupA).

Uplink resource configuration for MSGA: the uplink resource may be a Physical Uplink Shared Channel (PUSCH).

Other parameters, including one or more of the following: signal quality threshold corresponding to synchronization signal block (SSB) (for example, it may be rsrp-ThresholdSSB), signal quality threshold corresponding to MSG3 (for example, it may be rsrp-ThresholdMsg3), message power offset corresponding to GroupB (for example, it may be messagePowerOffsetGroupB), size of random access GroupA (for example, it may be ra-SizeGroupA), and delta Preamble (deltaPreamble). The signal quality may be RSRP, RSRQ, SINR, RSSI, or the like.

Configuration parameters, which may include one or more of the following: RACH configuration, total number of Preambles, SSB number for RACH occasions, size of Msg3, size of Msg3 corresponding to GroupA, size of Msg3 corresponding to GroupB, message power offset (MessagePowerOffset), message power offset corresponding to GroupB, message power offset corresponding to GroupA, total number of preambles corresponding to GroupA, total number of preambles corresponding to GroupB, contention resolution timer, RSRP threshold corresponding to SSB, RSRP threshold corresponding to SSB of a supplementation uplink, Root Sequence Index of PRACH (RootSequenceIndex), subcarrier spacing (SubcarrierSpacing), subcarrier spacing of Msg1, transformPrecoder of Msg3, priority, slice priority, uplink resource configuration, downlink resource configuration, RACH resource configuration, PRACH resource configuration, RACH occasion resource configuration, or the like.

In the disclosure, the slice identification may be Single Network Slice Selection Assistance Information (S-NSSAI).

In the disclosure, the TA obtaining related information may include, for example, an obtained TA value and/or related parameters used for calculating the TA value. The information may include one or more of the following: TA value, valid time of TA, time Offset, drift rate of a TA value, drift rate variation of a TA value, transmission and reception point (TRP) reception time of an uplink subframe containing a physical random access channel (PRACH) transmitted by the UE, TRP transmission time of a downlink subframe closest in time to the subframe received from the UE, preamble, preamble index, system frame number (SFN), synchronization signal block (SSB) index, RACH occasion (RO), RACH resource configuration, and RACH resource configuration for obtaining timing advance (TA) in advance. Herein, the TA value may include one or more of the following: time advance, time offset, or the like.

Various embodiments of the disclosure are further described below with reference to the accompanying drawings.

The text and drawings are provided as examples only to help understand the disclosure. They should not be construed as limiting the scope of the disclosure in any way. Although certain embodiments and examples have been provided, based on the disclosure herein, it is apparent to those skilled in the art that changes can be made to the illustrated embodiments and examples without departing from the scope of the disclosure.

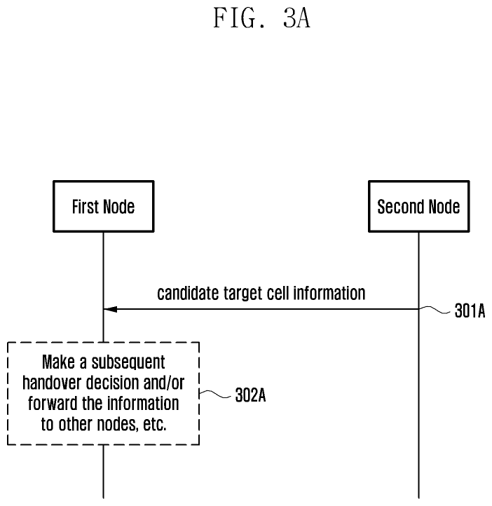

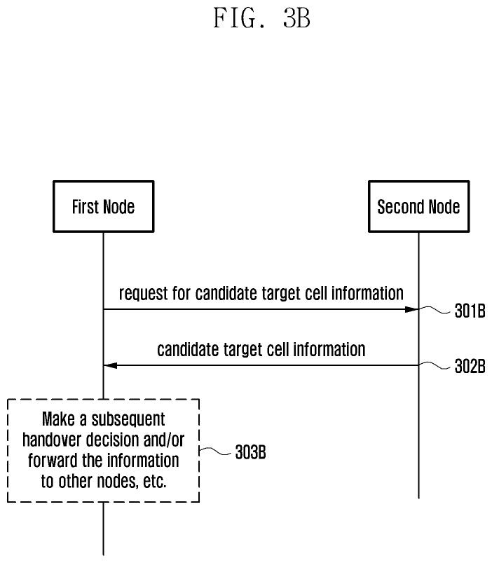

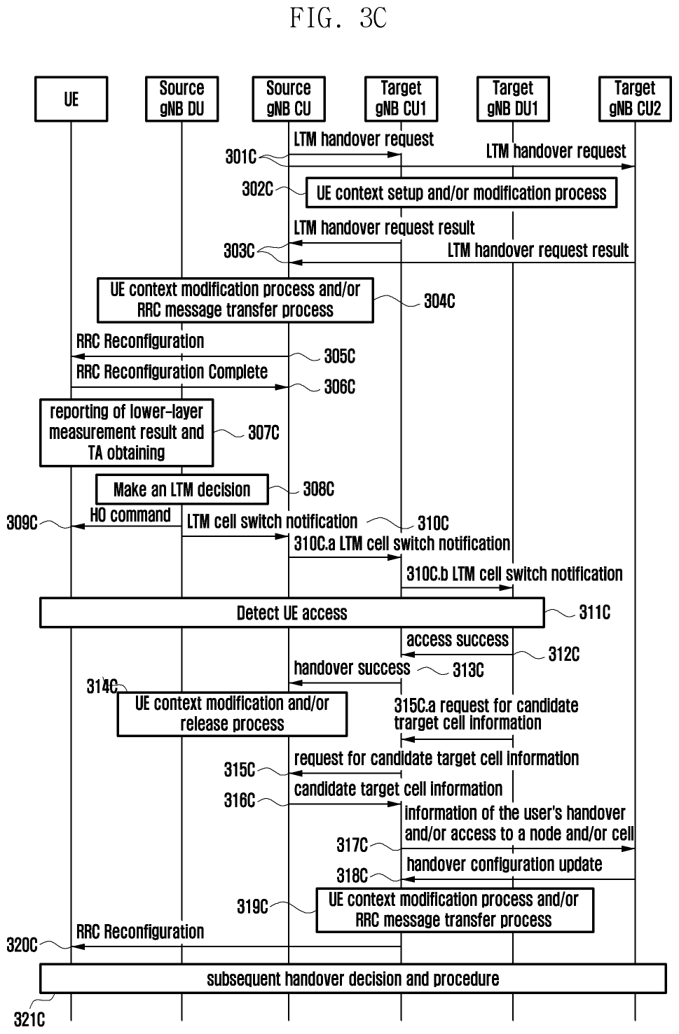

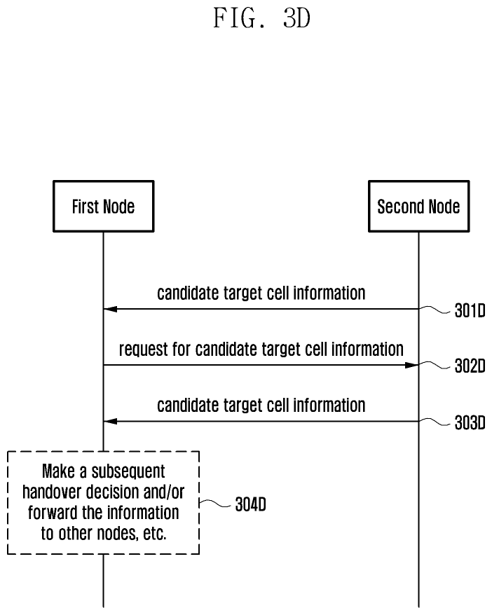

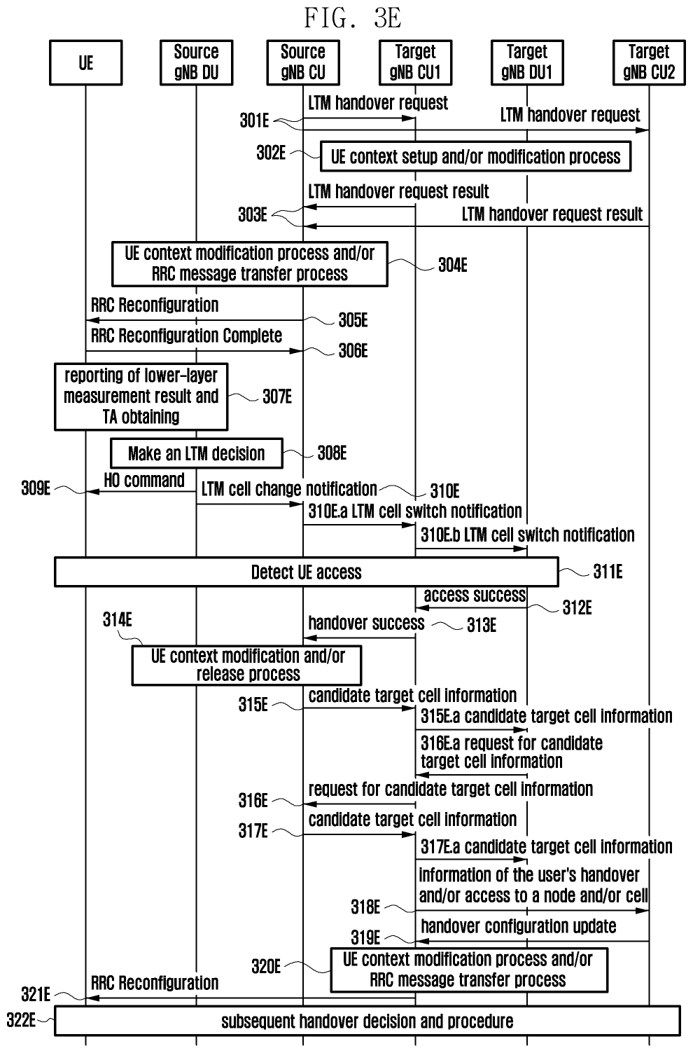

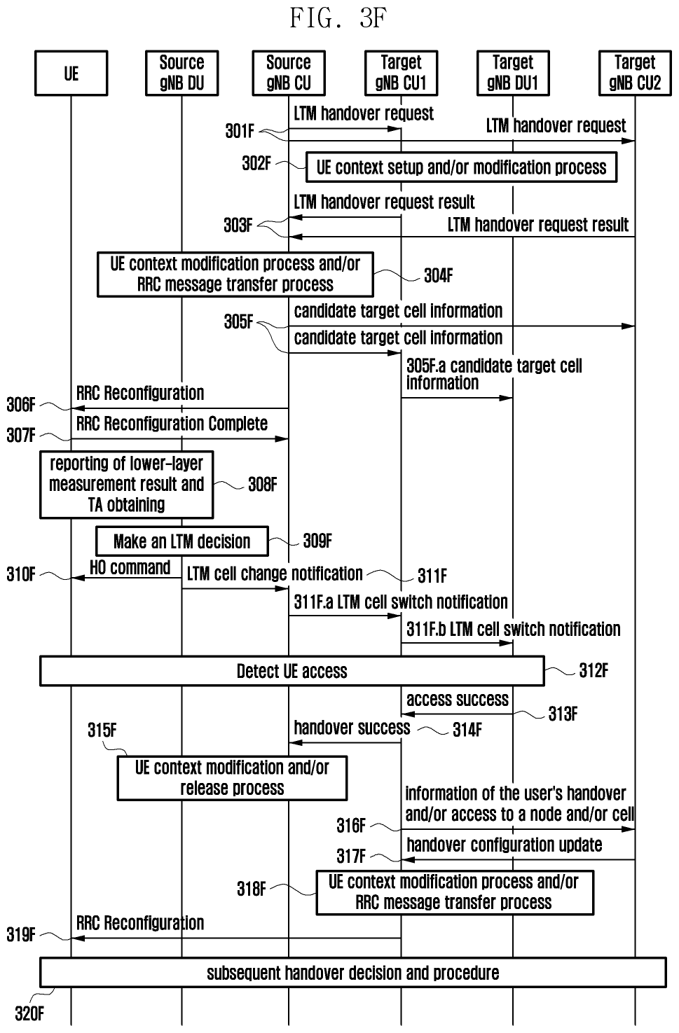

FIG. 3A shows a schematic diagram of an aspect of a method for supporting handover between nodes according to an embodiment of the disclosure. Specifically, FIG. 3A shows a process of exchanging candidate target cell information between two nodes, so that the first node can obtain the configuration information of the candidate target cell for making subsequent handover decisions. In an implementation, for example, the first node may be a gNB or a gNB-CU or a gNB-DU or a gNB CU-CP or a gNB CU-UP or an en-gNB or an eNB or a ng-eNB, and the second node may be a gNB or a gNB-CU or a gNB-DU or a gNB CU-CP or a gNB CU-UP or an en-gNB or an eNB or a ng-eNB. In another implementation, for example, the first node may be an AMF or an SMF or an MME, and the second node may be a gNB or a gNB-CU or a gNB CU-CP or an en-gNB or an eNB or a ng-eNB. In yet another implementation, for example, the first node may be a gNB or a gNB-CU or a gNB CU-CP or an en-gNB or an eNB or a ng-eNB, and the second node may be an AMF or an SMF or an MME. In yet another implementation, for example, the first node may be a gNB or a gNB-CU or a gNB-DU or a gNB CU-CP or a gNB CU-UP or an en-gNB or an eNB or a ng-eNB, and the second node may be a UE. In yet another implementation, for example, the first node may be a node newly accessed by the UE after handover, and the second node is a node accessed by the UE before handover. In yet another implementation, for example, the first node is a node where the candidate target cell is located, and the second node is a node currently accessed by the UE. In yet another implementation, for example, the first node may be a secondary node and/or a target secondary node and/or a Candidate Target Secondary Node in a dual-connectivity, and the second node may be a master node in a dual-connectivity. In yet another implementation, for example, the first node may be a master node in a dual-connectivity, and the second node may be a secondary node and/or a target secondary node and/or a Candidate Target Secondary Node in a dual-connectivity. In yet another implementation, for example, the first node may be a secondary node and/or a target secondary node and/or a Candidate Target Secondary Node in a dual-connectivity, and the second node may be a secondary node and/or a target secondary node and/or a Candidate Target Secondary Node in a dual-connectivity.

Step 301A: the second node transmits candidate target cell information to the first node. The candidate target cell information may be the aforementioned second message.

Step 302A: the first node forwards the received candidate target cell information to other nodes, and/or makes a subsequent handover decision based on the received candidate target cell information.

FIG. 3B shows a schematic diagram of an aspect of a method for supporting handover between nodes according to an embodiment of the disclosure. Specifically, FIG. 3B shows a process of exchanging candidate target cell information between two nodes, so that the first node can obtain the configuration information of the candidate target cell for making subsequent handover decisions. In an implementation, for example, the first node may be a gNB or a gNB-CU or a gNB-DU or a gNB CU-CP or a gNB CU-UP or an en-gNB or an eNB or a ng-eNB, and the second node may be a gNB or a gNB-CU or a gNB-DU or a gNB CU-CP or a gNB CU-UP or an en-gNB or an eNB or a ng-eNB. In another implementation, for example, the first node may be an AMF or an SMF or an MME, and the second node may be a gNB or a gNB-CU or a gNB CU-CP or an en-gNB or an eNB or a ng-eNB. In yet another implementation, for example, the first node may be a gNB or a gNB-CU or a gNB CU-CP or an en-gNB or an eNB or a ng-eNB, and the second node may be an AMF or an SMF or an MME. In yet another implementation, for example, the first node may be a gNB or a gNB-CU or a gNB-DU or a gNB CU-CP or a gNB CU-UP or an en-gNB or an eNB or a ng-eNB, and the second node may be a UE. In yet another implementation, for example, the first node may be a node newly accessed by the UE after handover, and the second node is a node accessed by the UE before handover. In yet another implementation, for example, the first node is a node where the candidate target cell is located, and the second node is a node currently accessed by the UE. In yet another implementation, for example, the first node may be a secondary node and/or a target secondary node and/or a Candidate Target Secondary Node in a dual-connectivity, and the second node may be a master node in a dual-connectivity. In yet another implementation, for example, the first node may be a master node in a dual-connectivity, and the second node may be a secondary node and/or a target secondary node and/or a Candidate Target Secondary Node in a dual-connectivity. In yet another implementation, for example, the first node may be a secondary node and/or a target secondary node and/or a Candidate Target Secondary Node in a dual-connectivity, and the second node may be a secondary node and/or a target secondary node and/or a Candidate Target Secondary Node in a dual-connectivity.

Step 301B: the first node transmits a request for candidate target cell information to the second node to request the second node to feedback relevant candidate target cell information to the first node. The request for candidate target cell information may be the aforementioned first message.

Step 302B: the second node transmits candidate target cell information to the first node. The candidate target cell information may be the aforementioned second message.

Step 303B: the first node forwards the received candidate target cell information to other nodes, and/or makes a subsequent handover decision based on the received candidate target cell information.

FIG. 3C shows a schematic diagram of an aspect of a method for supporting handover between nodes according to an embodiment of the disclosure. Specifically, FIG. 3C shows a process of exchanging candidate target cell information between nodes, so that a new accessing node of the user can obtain candidate target cell configuration information for the user, which can be used for making subsequent handover decisions.

Step 301C: the source node (or the source gNB CU) transmits an LTM handover request to the (candidate) target node (or the (candidate) target gNB CU) to trigger an LTM handover. The LTM handover request may be the fifth message mentioned above. In an implementation, the message may be carried by a handover request message.

Step 302C: the (candidate) target gNB CU and the (candidate) target gNB DU perform a UE context setup and/or modification process.

Step 303C: the (candidate) target node (or the (candidate) target gNB CU) transmits an LTM handover request result to the source node (or the source gNB). The result of the LTM handover request may be the sixth message described above. In an implementation, the message may be carried by a handover request acknowledge message.

Step 304C: the source gNB CU and the source gNB DU perform a UE context modification process and/or an RRC message transfer process, so as to transmit the configuration information of the target cell to the source gNB DU and/or transmit it to the user through the source gNB DU transparently.

Step 305C: the source node (or the source gNB CU) transmits an RRC reconfiguration message to the UE.

Step 306C: the UE transmits an RRC reconfiguration complete message to the source node (or the source gNB CU).

Step 307C: the UE and the source node perform a process of reporting of a lower-layer measurement result, and perform a process of TA obtaining.

Step 308C: the source node (or the source gNB DU) makes an LTM decision.

Step 309C: the source node (or the source gNB DU) transmits a handover (HO) command to the UE. For example, the handover command (which may also be a Cell Switch command) is to hand over the UE to a cell managed by target gNB CU1 and/or target gNB DU1.

Step 310C: the source gNB DU transmits an LTM cell switch notification to the source gNB CU.

Step 310C.a: optionally, after receiving the LTM cell switch notification, the source gNB CU may transmit the LTM cell switch notification to target gNB CU1.

Step 310C.b: optionally, after receiving the LTM cell switch notification, the target gNB CU1 may transmit the LTM cell switch notification to target gNB DU1. For example, this step is for the target node (for example, target gNB DU1) to detect whether the UE is accessed.

Step 311C: the target node detects whether the UE accesses.

This example takes UE's access to a cell in (candidate) target node 1 (or (candidate) target gNB DU1 and/or (candidate) target gNB CU1) as an example.

Step 312C: after the UE accesses a cell of the (candidate) target gNB DU1, the (candidate) target node and/or the (candidate) target gNB DU1 and/or the (candidate) target gNB CU1 are the new accessing nodes of the UE. The (candidate) target gNB DU1 informs the (candidate) target gNB DU1 of information about the UE's successful access through an access success message.

Step 313C: the (candidate) target gNB CU1 informs the source node (or the source gNB CU) that the UE has successfully accessed the cell in the (candidate) target node 1. The information of successful access may be the above-mentioned third message. The message may be carried by a handover success message.

Step 314C: the source gNB CU and the source gNB DU perform a process of UE context modification and/or release.

Step 315C.a: optionally, the new accessing node gNB DU of the UE (in this example, it is the (candidate) target node gNB DU1) transmits a candidate target cell information request to the new accessing node gNB CU of the UE (in this example, it is the (candidate) target node gNB CU1). The candidate target cell information request may be the first message mentioned above.

Step 315C: the new accessing node of the UE (in this example, it is the (candidate) target node 1, which is shown as (candidate) target node gNB DU1) transmits a candidate target cell information request to the original accessing node (in this example, it is the source node, which is shown as the source gNB CU). The candidate target cell information request may be the first message mentioned above.

Step 316C: the original accessing node (in this example, it is the source node, which is shown as the source gNB CU) transmits the candidate target cell information to the new accessing node of the UE (in this example, it is the (candidate) target node 1, which is shown as (candidate) target node gNB DU1). The candidate target cell information may be the above-mentioned second message.

Step 316C.a: optionally, the new accessing node gNB CU of the UE (in this example, it is the (candidate) target node gNB CU1) transmits the candidate target cell information to the new accessing node gNB DU of the UE (in this example, it is the (candidate) target node gNB DU1). The candidate target cell information may be the above-mentioned second message.

Step 317C: the new accessing node of the UE (in this example, it is the (candidate) target node 1) uses the obtained candidate target cell information to transmit the information about the user's handover and/or access to the (candidate) target node 1 and/or a corresponding cell to other (candidate) target nodes, and inform the other (candidate) target nodes of the user's current accessing node and/or cell. The handover and/or access information may be the above-mentioned third message.

Step 318C: if the (candidate) target node has an update of the handover configuration for the user, the (candidate) target node transmits handover configuration update information to the accessing node of the UE (in this example, it is the (candidate) target node 1). In some implementations, the configuration update information may be placed in an RRC container and transmitted to the user through the accessing node of the UE (in this example, it is the (candidate) target node 1) transparently. The handover configuration update information may be the aforementioned fourth message. Optionally, the accessing node CU of the UE (in this example, it is the (candidate) target gNB CU1) may transmit the handover configuration update information to the accessing node DU (in this example, it is the (candidate) target gNB DU1). Optionally, the accessing node of the UE (in this example, it is the (candidate) target node 1) may transmit the handover configuration update information to another (candidate) target node and/or the source node. The other (candidate) target node CU and/or source node CU may transmit the handover configuration update information to the other (candidate) target node DU and/or the source node DU.

Step 319C: the UE's accessing gNB CU (in this example, it is the (candidate) target gNB CU1) and the UE's accessing gNB DU (in this example, it is the (candidate) target gNB DU1) perform a process of UE context modification and/or a process of RRC message transfer.

Step 320C: the accessing node of the UE (in this example, it is the (candidate) target node 1), or the gNB CU, transmits an RRC reconfiguration message (including updated handover configuration information therein, for example) to the UE to inform the user of the latest configuration information.

Step 321C: the new accessing node of the UE (in this example, it is the (candidate) target node 1) uses the obtained candidate target cell information and/or the latest configuration update information to make subsequent handover decisions and corresponding procedures.

Herein, Step 315C may be omitted, or Step 315C may be merged into Step 313C. Steps 318C, 319C and 320C are optional steps. Step 314C may occur at the same time and/or before and/or after any of Steps 313C to 321C. Step 315C and/or Step 316C may occur before and/or at the same time and/or after any of Steps 304C to 314C. Herein, Step 315C.a may be omitted, or Step 315C.a may be merged into Step 313C.

FIG. 3D shows a schematic diagram of an aspect of a method for supporting handover between nodes according to an embodiment of the disclosure. Specifically, FIG. 3D shows a process of exchanging candidate target cell information between two nodes, so that the first node can obtain the configuration information of the candidate target cell for making subsequent handover decisions. In an implementation, for example, the first node may be a gNB or a gNB-CU or a gNB-DU or a gNB CU-CP or a gNB CU-UP or an en-gNB or an eNB or a ng-eNB, and the second node may be a gNB or a gNB-CU or a gNB-DU or a gNB CU-CP or a gNB CU-UP or an en-gNB or an eNB or a ng-eNB. In another implementation, for example, the first node may be an AMF or an SMF or an MME, and the second node may be a gNB or a gNB-CU or a gNB CU-CP or an en-gNB or an eNB or a ng-eNB. In yet another implementation, for example, the first node may be a gNB or a gNB-CU or a gNB CU-CP or an en-gNB or an eNB or a ng-eNB, and the second node may be an AMF or an SMF or an MME. In yet another implementation, for example, the first node may be a gNB or a gNB-CU or a gNB-DU or a gNB CU-CP or a gNB CU-UP or an en-gNB or an eNB or a ng-eNB, and the second node may be a UE. In yet another implementation, for example, the first node may be a node newly accessed by the UE after handover, and the second node is a node accessed by the UE before handover. In yet another implementation, for example, the first node is a node where the candidate target cell is located, and the second node is a node currently accessed by the UE. In yet another implementation, for example, the first node may be a secondary node and/or a target secondary node and/or a Candidate Target Secondary Node in a dual-connectivity, and the second node may be a master node in a dual-connectivity. In yet another implementation, for example, the first node may be a master node in a dual-connectivity, and the second node may be a secondary node and/or a target secondary node and/or a Candidate Target Secondary Node in a dual-connectivity. In yet another implementation, for example, the first node may be a secondary node and/or a target secondary node and/or a Candidate Target Secondary Node in a dual-connectivity, and the second node may be a secondary node and/or a target secondary node and/or a Candidate Target Secondary Node in a dual-connectivity.

Step 301D: the second node transmits candidate target cell information to the first node. The candidate target cell information may be the aforementioned second message. In some implementations, for example, this information may be part of the aforementioned second message. In some implementations, only identifications of candidate target cells and/or nodes may be included.

Step 302D: the first node transmits a request for candidate target cell information to the second node to request the second node to feedback relevant candidate target cell information to the first node. The request for candidate target cell information may be the aforementioned first message. In some implementations, for example, the first node can make a decision about whether to make a further request to obtain more information of the candidate target cell according to the received candidate cell information. For example, information of only some candidate cells and/or nodes may be requested.

Step 303D: the second node transmits candidate target cell information to the first node. The candidate target cell information may be the aforementioned second message.

Step 304D: the first node forwards the received candidate target cell information to other nodes, and/or makes a subsequent handover decision based on the received candidate target cell information.

FIG. 3E shows a schematic diagram of an aspect of a method for supporting handover between nodes according to an embodiment of the disclosure. Specifically, FIG. 3E shows a process of exchanging candidate target cell information between nodes, so that a new accessing node of the user can obtain candidate target cell configuration information for the user, which can be used for making subsequent handover decisions.

Step 301E: the source node (or the source gNB CU) transmits an LTM handover request to the (candidate) target node (or the (candidate) target gNB CU) to trigger an LTM handover. The LTM handover request may be the fifth message mentioned above. In an implementation, the message may be carried by a handover request message.

Step 302E: the (candidate) target gNB CU and the (candidate) target gNB DU perform a UE context setup and/or modification process.

Step 303E: the (candidate) target node (or the (candidate) target gNB CU) transmits an LTM handover request result to the source node (or the source gNB). The result of the LTM handover request may be the sixth message described above. In an implementation, the message may be carried by a handover request acknowledge message.

Step 304E: the source gNB CU and the source gNB DU perform a UE context modification process and/or an RRC message transfer process, so as to transmit the configuration information of the target cell to the source gNB DU and/or transmit it to the user through the source gNB DU transparently.

Step 305E: the source node (or the source gNB CU) transmits an RRC reconfiguration message to the UE.

Step 306E: the UE transmits an RRC reconfiguration complete message to the source node (or the source gNB CU).

Step 307E: the UE and the source node perform a process of reporting of a lower-layer measurement result, and perform a process of TA obtaining.

Step 308E: the source node (or the source gNB DU) makes an LTM decision.

Step 309E: the source node (or the source gNB DU) transmits a handover command to the UE. For example, the handover command (which may also be a Cell Switch command) is to hand over the UE to a cell managed by target gNB CU1 and/or target gNB DU1.

Step 310E: the source gNB DU transmits an LTM cell switch notification to the source gNB CU.

Step 310E.a: optionally, after receiving the LTM cell switch notification, the source gNB CU may transmit the LTM cell switch notification to target gNB CU1.

Step 310E.b: optionally, after receiving the LTM cell switch notification, the target gNB CU1 may transmit the LTM cell switch notification to target gNB DU1. For example, this step is for the target node (for example, target gNB DU1) to detect whether the UE is accessed.

Step 311E: the target node detects whether the UE accesses.

This example takes UE's access to a cell in (candidate) target node 1 (or (candidate) target gNB DU1 and/or (candidate) target gNB CU1) as an example.

Step 312E: after the UE accesses a cell of the (candidate) target gNB DU1, the (candidate) target node and/or the (candidate) target gNB DU1 and/or the (candidate) target gNB CU1 are the new accessing nodes of the UE. The (candidate) target gNB DU1 informs the (candidate) target gNB DU1 of information about the UE's successful access through an access success message.

Step 313E: the (candidate) target gNB CU1 informs the source node (or the source gNB CU) that the UE has successfully accessed the cell in the (candidate) target node 1. The information of successful access may be the above-mentioned third message. The message may be carried by a handover success message.

Step 314E: the source gNB CU and the source gNB DU perform a process of UE context modification and/or release.

Step 315E: the original accessing node (in this example, it is the source node, which is shown as the source gNB CU) transmits the candidate target cell information to the new accessing node of the UE (in this example, it is the (candidate) target node 1, which is shown as (candidate) target node gNB DU1). The candidate target cell information may be the above-mentioned second message. In some implementations, for example, this information may be part of the aforementioned second message. In some implementations, only identifications of candidate target cells and/or nodes may be included.

Step 315E.a: optionally, the new accessing node gNB CU of the UE (in this example, it is the (candidate) target node gNB CU1) transmits the candidate target cell information to the new accessing node gNB DU of the UE (in this example, it is the (candidate) target node gNB DU1). The candidate target cell information may be the above-mentioned second message. In some implementations, for example, this information may be part of the aforementioned second message. In some implementations, only identifications of candidate target cells and/or nodes may be included.

Step 316E.a: optionally, the new accessing node gNB DU of the UE (in this example, it is the (candidate) target node gNB DU1) transmits a candidate target cell information request to the new accessing node gNB CU of the UE (in this example, it is the (candidate) target node gNB CU1). The candidate target cell information request may be the first message mentioned above.

Step 316E: the new accessing node of the UE (in this example, it is the (candidate) target node 1) transmits a candidate target cell information request to the original accessing node (in this example, it is the source node). The candidate target cell information request may be the first message mentioned above. In some implementations, for example, a new accessing node (in this example, it is the (candidate) target node 1) can make a decision about whether to make a further request to obtain more information of the candidate target cell according to the received candidate cell information. For example, information of only some candidate cells and/or nodes may be requested.

Step 317E: the original accessing node (in this example, it is the source node) transmits the candidate target cell information to the new accessing node of the UE (in this example, it is the (candidate) target node 1). The candidate target cell information may be the above-mentioned second message.

Step 317E.a: optionally, the new accessing node gNB CU of the UE (in this example, it is the (candidate) target node gNB CU1) transmits the candidate target cell information to the new accessing node gNB DU of the UE (in this example, it is the (candidate) target node gNB DU1). The candidate target cell information may be the above-mentioned second message.

Step 318E: the new accessing node of the UE (in this example, it is the (candidate) target node 1) uses the obtained candidate target cell information to transmit the information about the user's handover and/or access to the (candidate) target node 1 and/or a corresponding cell to other (candidate) target nodes, and inform the other (candidate) target nodes of the user's current accessing node and/or cell. The handover and/or access information may be the above-mentioned third message.

Step 319E: if the (candidate) target node has an update of the handover configuration for the user, the (candidate) target node transmits handover configuration update information to the accessing node of the UE (in this example, it is the (candidate) target node 1). In some implementations, the configuration update information may be placed in an RRC container and transmitted to the user through the accessing node of the UE (in this example, it is the (candidate) target node 1) transparently. The handover configuration update information may be the aforementioned fourth message. Optionally, the accessing node CU of the UE (in this example, it is the (candidate) target gNB CU1) may transmit the handover configuration update information to the accessing node DU (in this example, it is the (candidate) target gNB DU1). Optionally, the accessing node of the UE (in this example, it is the (candidate) target node 1) may transmit the handover configuration update information to another (candidate) target node and/or the source node. The other (candidate) target node CU and/or source node CU may transmit the handover configuration update information to the other (candidate) target node DU and/or the source node DU.

Step 320E: the UE's accessing gNB CU (in this example, it is the (candidate) target gNB CU1) and the UE's accessing gNB DU (in this example, it is the (candidate) target gNB DU1) perform a process of UE context modification and/or a process of RRC message transfer.

Step 321E: the accessing node of the UE (in this example, it is the (candidate) target node 1), or the gNB CU, transmits an RRC reconfiguration message (including updated handover configuration information therein, for example) to the UE to inform the user of the latest configuration information.

Step 322E: the new accessing node of the UE (in this example, it is the (candidate) target node 1) uses the obtained candidate target cell information and/or the latest configuration update information to make subsequent handover decisions and corresponding procedures.

Steps 319E, 320E and 321E are optional. Step 314E may occur at the same time and/or before and/or after any of Steps 315E to 322E. Step 315E, Step 315E.a, Step 315E.b, Step 316E, Step 317E and Step 317E.a may occur before and/or at the same time and/or after any step of Step 304E to Step 314E.

FIG. 3F shows a schematic diagram of an aspect of a method for supporting handover between nodes according to an embodiment of the disclosure. Specifically, FIG. 3F shows a process of exchanging candidate target cell information between nodes, so that a new accessing node of the user can obtain candidate target cell configuration information for the user, which can be used for making subsequent handover decisions.

Step 301F: the source node (or the source gNB CU) transmits an LTM handover request to the (candidate) target node (or the (candidate) target gNB CU) to trigger an LTM handover. The LTM handover request may be the fifth message mentioned above. In an implementation, the message may be carried by a handover request message.

Step 302F: the (candidate) target gNB CU and the (candidate) target gNB DU perform a UE context setup and/or modification process.

Step 303F: the (candidate) target node (or the (candidate) target gNB CU) transmits an LTM handover request result to the source node (or the source gNB). The result of the LTM handover request may be the sixth message described above. In an implementation, the message may be carried by a handover request acknowledge message.

Step 304F: the source gNB CU and the source gNB DU perform a UE context modification process and/or an RRC message transfer process, so as to transmit the configuration information of the target cell to the source gNB DU and/or transmit it to the user through the source gNB DU transparently.

Step 305F: the source node (or the source gNB CU) transmits information of all and/or partial candidate target cells to all and/or partial (candidate) target nodes. The candidate target cell information may be the above-mentioned second message. In some implementations, for example, this information may be part of the aforementioned second message.

Step 305F.a: optionally, the (candidate) target node gNB CU transmits candidate target cell information to the (candidate) target node gNB DU. The candidate target cell information may be the above-mentioned second message. In some implementations, for example, this information may be part of the aforementioned second message.

Step 306F: the source node (or the source gNB CU) transmits an RRC reconfiguration message to the UE.

Step 307F: the UE transmits an RRC reconfiguration complete message to the source node (or the source gNB CU).

Step 308F: the UE and the source node perform a process of reporting of a lower-layer measurement result, and perform a process of TA obtaining.

Step 309F: the source node (or the source gNB DU) makes an LTM decision.

Step 310F: the source node (or the source gNB DU) transmits a handover command to the UE. For example, the handover command (which may also be a Cell Switch command) is to hand over the UE to a cell managed by target gNB CU1 and/or target gNB DU1.

Step 311F: the source gNB DU transmits an LTM cell switch notification to the source gNB CU.

Step 311F.a: optionally, after receiving the LTM cell switch notification, the source gNB CU may transmit the LTM cell switch notification to target gNB CU1.

Step 311F.b: optionally, after receiving the LTM cell switch notification, the target gNB CU1 may transmit the LTM cell switch notification to target gNB DU1. For example, this step is for the target node (for example, target gNB DU1) to detect whether the UE is accessed.

Step 312F: the target node detects whether the UE accesses.

This example takes UE's access to a cell in (candidate) target node 1 (or (candidate) target gNB DU1 and/or (candidate) target gNB CU1) as an example.

Step 313F: after the UE accesses a cell of the (candidate) target gNB DU1, the (candidate) target node and/or the (candidate) target gNB DU1 and/or the (candidate) target gNB CU1 are the new accessing nodes of the UE. The (candidate) target gNB DU1 informs the (candidate) target gNB DU1 of information about the UE's successful access through an access success message.

Step 314F: the (candidate) target gNB CU1 informs the source node (or the source gNB CU) that the UE has successfully accessed the cell in the (candidate) target node 1. The information of successful access may be the above-mentioned third message. The message may be carried by a handover success message.

Step 315F: the source gNB CU and the source gNB DU perform a process of UE context modification and/or release.

Step 316F: the new accessing node of the UE (in this example, it is the (candidate) target node 1) uses the obtained candidate target cell information to transmit the information about the user's handover and/or access to the (candidate) target node 1 and/or a corresponding cell to other (candidate) target nodes, and inform the other (candidate) target nodes of the user's current accessing node and/or cell. The handover and/or access information may be the above-mentioned third message.

Step 317F: if the (candidate) target node has an update of the handover configuration for the user, the (candidate) target node transmits handover configuration update information to the accessing node of the UE (in this example, it is the (candidate) target node 1). In some implementations, the configuration update information may be placed in an RRC container and transmitted to the user through the accessing node of the UE (in this example, it is the (candidate) target node 1) transparently. The handover configuration update information may be the aforementioned fourth message. Optionally, the accessing node CU of the UE (in this example, it is the (candidate) target gNB CU1) may transmit the handover configuration update information to the accessing node DU (in this example, it is the (candidate) target gNB DU1). Optionally, the accessing node of the UE (in this example, it is the (candidate) target node 1) may transmit the handover configuration update information to another (candidate) target node and/or the source node. The other (candidate) target node CU and/or source node CU may transmit the handover configuration update information to the other (candidate) target node DU and/or the source node DU.

Step 318F: the UE's accessing gNB CU (in this example, it is the (candidate) target gNB CU1) and the UE's accessing gNB DU (in this example, it is the (candidate) target gNB DU1) perform a process of UE context modification and/or a process of RRC message transfer.

Step 319F: the accessing node of the UE (in this example, it is the (candidate) target node 1), or the gNB CU, transmits an RRC reconfiguration message (including updated handover configuration information therein, for example) to the UE to inform the user of the latest configuration information.

Step 320F: the new accessing node of the UE (in this example, it is the (candidate) target node 1) uses the obtained candidate target cell information and/or the latest configuration update information to make subsequent handover decisions and corresponding procedures.

Step 305F and/or Step 305F.a may occur before and/or after and/or at the same time with Step 304F and/or Step 306F and/or Step 307F and/or Step 308F and/or Step 309F and/or Step 310F and/or Step 311F and/or Step 311F.a and/or Step 311F.b and/or Step 312F and/or Step 313F and/or Step 314F and/or Step 315F.

Steps 317F, 318F and 319F are optional steps. Step 315F may occur at the same time and/or before and/or after any of Steps 316F to 320F.

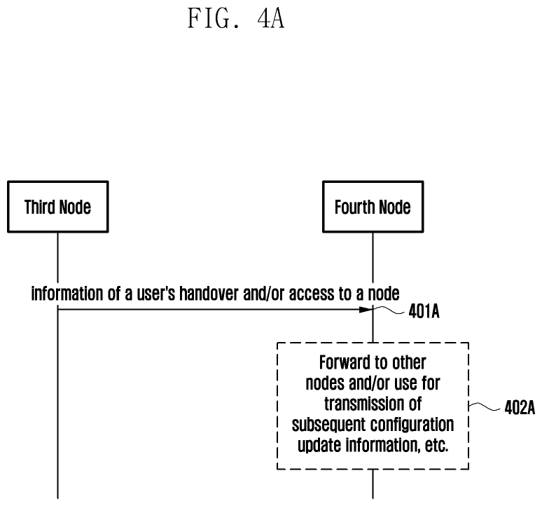

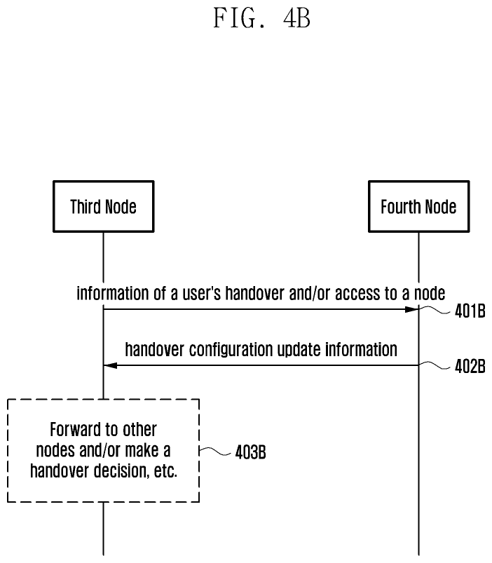

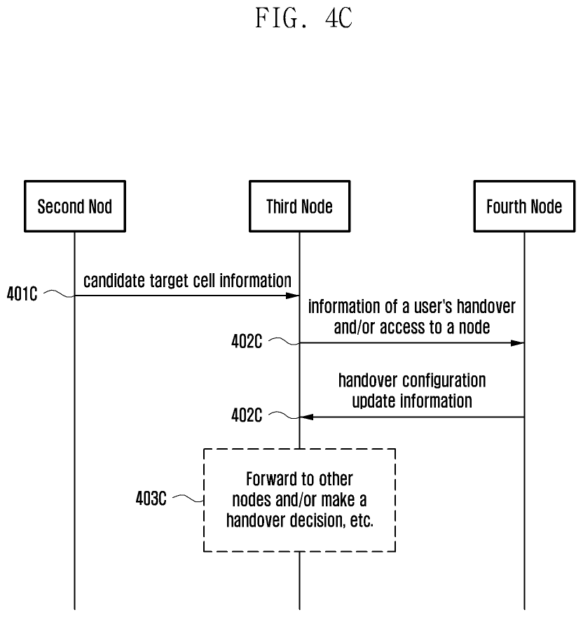

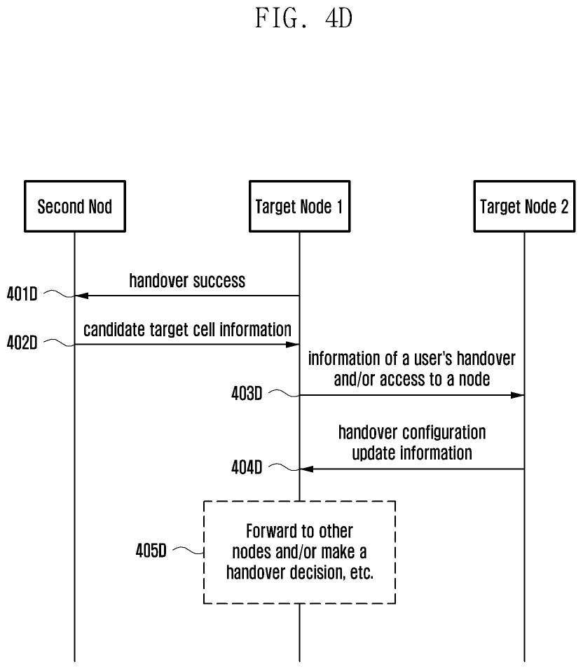

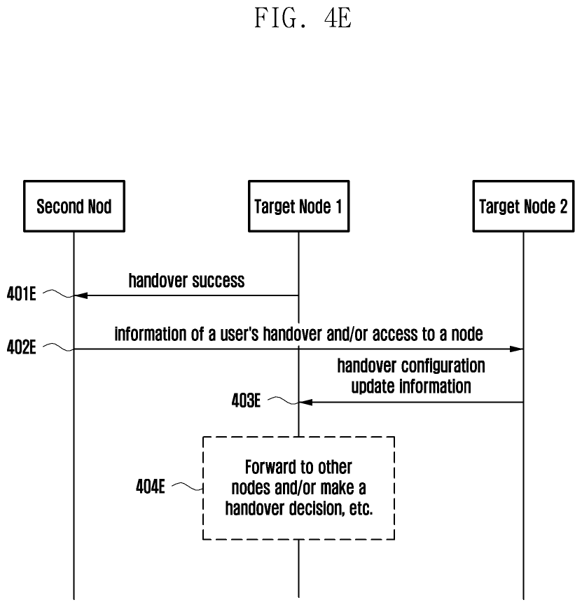

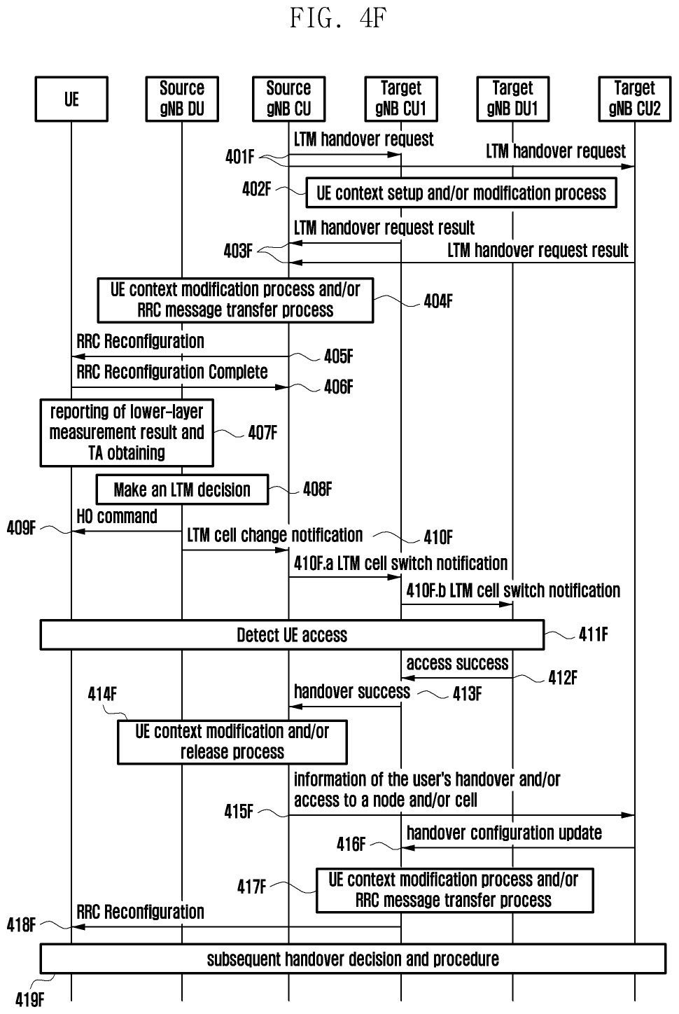

FIG. 4A shows a schematic diagram of an aspect of a method for supporting handover between nodes according to an embodiment of the disclosure. Specifically, FIG. 4A shows a process of exchanging information of user's handover and/or access to a node between two nodes, so that the fourth node can know that the user is handed over and/or accessed to a certain node, and the fourth node can forward the information to other nodes, or use it for transmission of subsequent configuration update information, for example, performing transmission by serving the node to which the user is handed over and/or accessed as the receiving node of the configuration update information. In an implementation, for example, the third node may be a gNB or a gNB-CU or a gNB-DU or a gNB CU-CP or a gNB CU-UP or an en-gNB or an eNB or a ng-eNB, and the fourth node may be a gNB or a gNB-CU or a gNB-DU or a gNB CU-CP or a gNB CU-UP or an en-gNB or an eNB or a ng-eNB. In another implementation, for example, the third node may be an AMF or an SMF or an MME, and the fourth node may be a gNB or a gNB-CU or a gNB CU-CP or an en-gNB or an eNB or a ng-eNB. In yet another implementation, for example, the third node may be a gNB or a gNB-CU or a gNB CU-CP or an en-gNB or an eNB or a ng-eNB, and the fourth node may be an AMF or an SMF or an MME. In yet another implementation, for example, the third node may be a node newly accessed by the UE after handover, and the fourth node is a node accessed by the UE before handover. In yet another implementation, for example, the third node is a node currently accessed by the UE, and the fourth node is a node where the candidate target cell is located. In yet another implementation, for example, the third node may be a secondary node accessed by the user in a dual-connectivity, and the fourth node may be a master node in a dual-connectivity. In yet another implementation, for example, the third node may be a secondary node accessed by the user in a dual-connectivity, and the fourth node may be a target secondary node and/or a Candidate Target Secondary Node. In yet another implementation, for example, the third node may be a master node, and the fourth node may be a target secondary node and/or a Candidate Target Secondary Node.

Step 401A: the third node transmits the information of the user's handover and/or access to a node to the fourth node. The information of the user's handover and/or access to a node may be the aforementioned third message.

Step 402A: the fourth node can forward the information to other nodes, or use it for transmission of subsequent configuration update information, for example, performing transmission by serving the node to which the user is handed over and/or accessed as the receiving node of the configuration update information.

FIG. 4B shows a schematic diagram of an aspect of a method for supporting handover between nodes according to an embodiment of the disclosure. Specifically, FIG. 4B shows a process of exchanging information of user's handover and/or access to a node between two nodes, so that the fourth node can know that the user is handed over and/or accessed to a certain node, and the fourth node can forward the information to other nodes, or use it for transmission of subsequent configuration update information, for example, performing transmission by serving the node to which the user is handed over and/or accessed as the receiving node of the configuration update information. In an implementation, for example, the third node may be a gNB or a gNB-CU or a gNB-DU or a gNB CU-CP or a gNB CU-UP or an en-gNB or an eNB or a ng-eNB, and the fourth node may be a gNB or a gNB-CU or a gNB-DU or a gNB CU-CP or a gNB CU-UP or an en-gNB or an eNB or a ng-eNB. In another implementation, for example, the third node may be an AMF or an SMF or an MME, and the fourth node may be a gNB or a gNB-CU or a gNB CU-CP or an en-gNB or an eNB or a ng-eNB. In yet another implementation, for example, the third node may be a gNB or a gNB-CU or a gNB CU-CP or an en-gNB or an eNB or a ng-eNB, and the fourth node may be an AMF or an SMF or an MME. In yet another implementation, for example, the third node may be a node newly accessed by the UE after handover, and the fourth node is a node accessed by the UE before handover. In yet another implementation, for example, the third node is a node currently accessed by the UE, and the fourth node is a node where the candidate target cell is located. In yet another implementation, for example, the third node may be a secondary node accessed by the user in a dual-connectivity, and the fourth node may be a master node in a dual-connectivity. In yet another implementation, for example, the third node may be a secondary node accessed by the user in a dual-connectivity, and the fourth node may be a target secondary node and/or a Candidate Target Secondary Node. In yet another implementation, for example, the third node may be a master node, and the fourth node may be a target secondary node and/or a Candidate Target Secondary Node.

Step 401B: the third node transmits the information of the user's handover and/or access to a node to the fourth node. The information of the user's handover and/or access to a node may be the aforementioned third message.

Step 402B: the fourth node transmits handover configuration update information to the third node. The handover configuration update information may be the aforementioned fourth message.

Step 403B: the third node may forward the handover configuration update information to other nodes and/or use it for making handover decisions.

FIG. 4C shows a schematic diagram of an aspect of a method for supporting handover between nodes according to an embodiment of the disclosure. Specifically, FIG. 4C shows a process of exchanging information of user's handover and/or access to a node between two nodes, so that the fourth node can know that the user is handed over and/or accessed to a certain node, and the fourth node can forward the information to other nodes, or use it for transmission of subsequent configuration update information, for example, performing transmission by serving the node to which the user is handed over and/or accessed as the receiving node of the configuration update information. In an implementation, for example, the second node may be a gNB or a gNB-CU or a gNB-DU or a gNB CU-CP or a gNB CU-UP or an en-gNB or an eNB or a ng-eNB, the third node may be a gNB or a gNB-CU or a gNB-DU or a gNB CU-CP or a gNB CU-UP or an en-gNB or an eNB or a ng-eNB, and the fourth node may be a gNB or a gNB-CU or a gNB-DU or a gNB CU-CP or a gNB CU-UP or an en-gNB or an eNB or a ng-eNB. In another implementation, for example, the second node may be a gNB or a gNB-CU or a gNB-DU or a gNB CU-CP or a gNB CU-UP or an en-gNB or an eNB or a ng-eNB, the third node may be an AMF or an SMF or an MME, and the fourth node may be a gNB or a gNB-CU or a gNB CU-CP or an en-gNB or an eNB or a ng-eNB. In yet another implementation, for example, the third node may be a gNB or a gNB-CU or a gNB CU-CP or an en-gNB or an eNB or a ng-eNB, and the fourth node may be an AMF or an SMF or an MME. In yet another implementation, for example, the second node is the node accessed by the UE before handover, the third node may be the node newly accessed by the UE after handover, and the fourth node is a node where the candidate target cell is located. In yet another implementation, for example, the second node is a node accessed by the UE before, the third node is a node currently accessed by the UE, and the fourth node is a node where the candidate target cell is located.

Step 401C: the second node transmits the candidate target cell information to the third node. The candidate target cell information may be the aforementioned second message. The candidate target cell information may use one or more of the following to identify the UE: identification assigned by the second node for the user, identification assigned by the third node for the user, identification assigned by the fourth node for the user, identification of the second node, identification of the third node, identification of the fourth node.

Step 402C: the third node transmits the information of the user's handover and/or access to a node to the fourth node. The information of the user's handover and/or access to a node may be the aforementioned third message. The candidate target cell information may use one or more of the following to identify the UE: identification assigned by the second node for the user, identification assigned by the third node for the user, identification assigned by the fourth node for the user, identification of the second node, identification of the third node, identification of the fourth node.

Step 403C: the fourth node transmits handover configuration update information to the third node. The handover configuration update information may be the aforementioned fourth message. The candidate target cell information may use one or more of the following to identify the UE: identification assigned by the second node for the user, identification assigned by the third node for the user, identification assigned by the fourth node for the user, identification of the second node, identification of the third node, identification of the fourth node.

Step 404C: the third node may forward the handover configuration update information to other nodes and/or use it for making handover decisions.

FIG. 4D shows a schematic diagram of an aspect of a method for supporting handover between nodes according to an embodiment of the disclosure. Specifically, FIG. 4D shows a process that when a user accesses one of the target nodes (for example, target node 1), the user's accessing node transmits information of the user's handover and/or access to the node to other candidate target nodes (for example, target node 2), so that the other candidate target nodes can know that the user is handed over and/or accessed to a certain node, and the other candidate target nodes can forward the information to other nodes, or use it for transmission of subsequent configuration update information, for example, performing transmission by serving the node to which the user is handed over and/or accessed as the receiving node of the configuration update information.

Step 401D: after the user successfully accesses the target node 1, the target node 1 transmits a message that the user successfully accesses the target node 1 to the source node. The information of the user's handover and/or access to a node may be the aforementioned third message.

Step 402D: the source node transmits the candidate target cell information to the target node 1. The candidate target cell information may be the aforementioned second message. The candidate target cell information may use one or more of the following to identify the UE: identification assigned by the source node for the user, identification assigned by the candidate target cell for the user, identification assigned by the target node 1 for the user, identification of the source node, identification of the candidate target cell, identification of the target node 1.

Step 403D: based on the received candidate target cell information, the target node 1 transmits the information of the user's handover and/or access to a node to other candidate target nodes (in this example, it is the target node 2). The information of the user's handover and/or access to a node may be the aforementioned third message. The message may use one or more of the following to identify the UE: identification assigned by the source node for the user, identification assigned by the candidate target cell for the user, identification assigned by the target node 1 for the user, identification of the source node, identification of the candidate target cell, identification of the target node 1.

Step 404D: if the target node 2 needs to update configuration, the target node 2 transmits handover configuration update information to the target node 1. The handover configuration update information may be the aforementioned fourth message. The message may use one or more of the following to identify the UE: identification assigned by the source node for the user, identification assigned by the candidate target cell for the user, identification assigned by the target node 1 for the user, identification of the source node, identification of the candidate target cell, identification of the target node 1.

Step 405D: the target node 1 may forward the handover configuration update information to other nodes and/or use it for making handover decisions. In an implementation, for example, the target node 1 may transmit handover configuration update information to the user for subsequent handover by the user. In another implementation, for example, the target node 1 may make a handover decision or the like based on the handover configuration update information.

Herein, Step 402D may occur before Step 401D.

FIG. 4E shows a schematic diagram of an aspect of a method for supporting handover between nodes according to an embodiment of the disclosure. Specifically, FIG. 4E shows a process that when a user accesses one of the target nodes (e.g., target node 1), the source node transmits information of the user's handover and/or access to the node to other candidate target nodes (e.g., target node 2), so that the other candidate target nodes can know that the user is handed over and/or accessed to a certain node, and the other candidate target nodes can forward the information to other nodes, or use it for transmission of subsequent configuration update information, for example, performing transmission by serving the node to which the user is handed over and/or accessed as the receiving node of the configuration update information.

Step 401E: after the user successfully accesses the target node 1, the target node 1 transmits a message that the user successfully accesses the target node 1 to the source node. The information of the user's handover and/or access to a node may be the aforementioned third message.

Step 402E: the source node transmits the information of the user's handover and/or access to a node to other candidate target nodes (in this example, it is the target node 2). The information of the user's handover and/or access to a node may be the aforementioned third message.

Step 403E: if the target node 2 needs to update configuration, the target node 2 transmits handover configuration update information to the target node 1. The handover configuration update information may be the aforementioned fourth message. The message may use one or more of the following to identify the UE: identification assigned by the source node for the user, identification assigned by the candidate target cell for the user, identification assigned by the target node 1 for the user, identification of the source node, identification of the candidate target cell, identification of the target node 1.

Step 404E: the target node 1 may forward the handover configuration update information to other nodes and/or use it for making handover decisions. In an implementation, for example, the target node 1 may transmit handover configuration update information to the user for subsequent handover by the user. In another implementation, for example, the target node 1 may make a handover decision or the like based on the handover configuration update information.

FIG. 4F shows a schematic diagram of an aspect of a method for supporting handover between nodes according to an embodiment of the disclosure. Specifically, FIG. 4F shows a process of exchanging information of the user's handover and/or access to a node between nodes, so that the candidate target nodes can know that the user is handed over and/or accessed to a certain node, and the candidate target nodes can forward the information to other nodes, or use it for transmission of subsequent configuration update information, for example, performing transmission by serving the node to which the user is handed over and/or accessed as the receiving node of the configuration update information.

Step 401F: the source node (or the source gNB CU) transmits an LTM handover request to the (candidate) target node (or the (candidate) target gNB CU) to trigger an LTM handover. The LTM handover request may be the fifth message mentioned above. In an implementation, the message may be carried by a handover request message.

Step 402F: the (candidate) target gNB CU and the (candidate) target gNB DU perform a UE context setup and/or modification process.

Step 403F: the (candidate) target node (or the (candidate) target gNB CU) transmits an LTM handover request result to the source node (or the source gNB). The result of the LTM handover request may be the sixth message described above. In an implementation, the message may be carried by a handover request acknowledge message.

Step 404F: the source gNB CU and the source gNB DU perform a UE context modification process and/or an RRC message transfer process, so as to transmit the configuration information of the target cell to the source gNB DU and/or transmit it to the user through the source gNB DU transparently.

Step 405F: the source node (or the source gNB CU) transmits an RRC reconfiguration message to the UE.

Step 406F: the UE transmits an RRC reconfiguration complete message to the source node (or the source gNB CU).

Step 407F: the UE and the source node perform a process of reporting of a lower-layer measurement result, and perform a process of TA obtaining.

Step 408F: the source node (or the source gNB DU) makes an LTM decision.

Step 409F: the source node (or the source gNB DU) transmits a handover command to the UE. For example, the handover command (which may also be a Cell Switch command) is to hand over the UE to a cell managed by target gNB CU1 and/or target gNB DU1.

Step 410F: the source gNB DU transmits an LTM cell switch notification to the source gNB CU.

Step 410F.a: optionally, after receiving the LTM cell switch notification, the source gNB CU may transmit the LTM cell switch notification to target gNB CU1.

Step 410F.b: optionally, after receiving the LTM cell switch notification, the target gNB CU1 may transmit the LTM cell switch notification to target gNB DU1. For example, this step is for the target node (for example, target gNB DU1) to detect whether the UE is accessed.

Step 411F: the target node detects whether the UE accesses.

This example takes UE's access to a cell in (candidate) target node 1 (or (candidate) target gNB DU1 and/or (candidate) target gNB CU1) as an example.

Step 412F: after the UE accesses a cell of the (candidate) target gNB DU1, the (candidate) target node and/or the (candidate) target gNB DU1 and/or the (candidate) target gNB CU1 are the new accessing nodes of the UE. The (candidate) target gNB DU1 informs the (candidate) target gNB DU1 of information about the UE's successful access through an access success message.

Step 413F: the (candidate) target gNB CU1 informs the source node (or the source gNB CU) that the UE has successfully accessed the cell in the (candidate) target node 1. The information of successful access may be the above-mentioned third message. The message may be carried by a handover success message.

Step 414F: the source gNB CU and the source gNB DU perform a process of UE context modification and/or release.

Step 415F: the source gNB CU transmits the information of the user's handover and/or access to the (candidate) target node 1 and/or the corresponding cell to other (candidate) target nodes, and informs the other (candidate) target nodes of the user's current accessing node and/or cell. The handover and/or access information may be the above-mentioned third message.

Step 416F: if the (candidate) target node has an update of the handover configuration for the user, the (candidate) target node transmits handover configuration update information to the accessing node of the UE (in this example, it is the (candidate) target node 1). In some implementations, the configuration update information may be placed in an RRC container and transmitted to the user through the accessing node of the UE (in this example, it is the (candidate) target node 1) transparently. The handover configuration update information may be the aforementioned fourth message. Optionally, the accessing node CU of the UE (in this example, it is the (candidate) target gNB CU1) may transmit the handover configuration update information to the accessing node DU (in this example, it is the (candidate) target gNB DU1). Optionally, the accessing node of the UE (in this example, it is the (candidate) target node 1) may transmit the handover configuration update information to another (candidate) target node and/or the source node. The other (candidate) target node CU and/or source node CU may transmit the handover configuration update information to the other (candidate) target node DU and/or the source node DU.

Step 417F: the UE's accessing gNB CU (in this example, it is the (candidate) target gNB CU1) and the UE's accessing gNB DU (in this example, it is the (candidate) target gNB DU1) perform a process of UE context modification and/or a process of RRC message transfer.

Step 418F: the accessing node of the UE (in this example, it is the (candidate) target node 1), or the gNB CU, transmits an RRC reconfiguration message (including updated handover configuration information therein, for example) to the UE to inform the user of the latest configuration information.

Step 419F: the new accessing node of the UE (in this example, it is the (candidate) target node 1) uses the obtained candidate target cell information and/or the latest configuration update information to make subsequent handover decisions and corresponding procedures.

Herein, Step 416F, Step 417F and Step 418F are optional steps. Step 414F may occur at the same time and/or before and/or after any of Steps 415F to 419F.

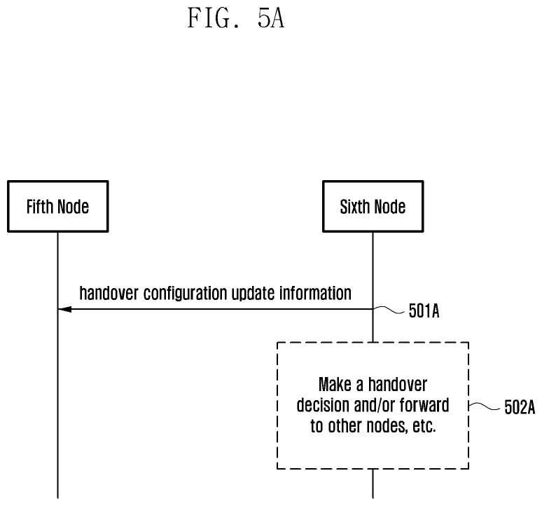

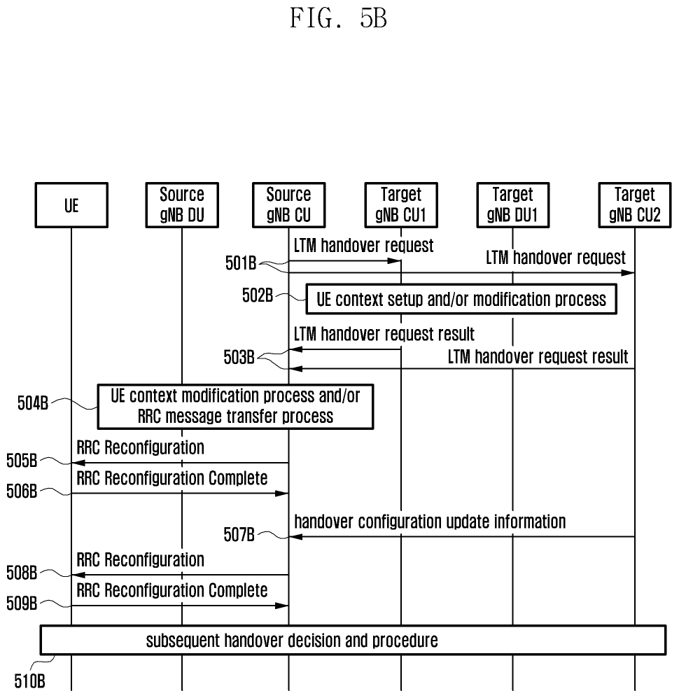

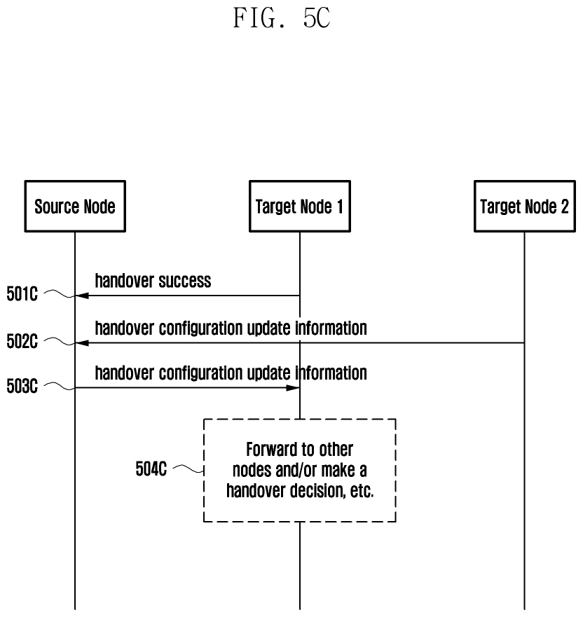

FIG. 5A shows a schematic diagram of an aspect of a method for supporting handover between nodes according to an embodiment of the disclosure. Specifically, FIG. 5A shows a process of exchanging handover configuration update information between two nodes, so that the sixth node can obtain the updated handover configuration, and the sixth node can use it for making handover decisions, and can also forward it to other nodes for making handover decisions. In an implementation, for example, the fifth node may be a gNB or a gNB-CU or a gNB-DU or a gNB CU-CP or a gNB CU-UP or an en-gNB or an eNB or a ng-eNB, and the sixth node may be a gNB or a gNB-CU or a gNB-DU or a gNB CU-CP or a gNB CU-UP or an en-gNB or an eNB or a ng-eNB. In another implementation, for example, the fifth node may be an AMF or an SMF or an MME, and the sixth node may be a gNB or a gNB-CU or a gNB CU-CP or an en-gNB or an eNB or a ng-eNB. In yet another implementation, for example, the fifth node may be a gNB or a gNB-CU or a gNB CU-CP or an en-gNB or an eNB or a ng-eNB, and the sixth node may be an AMF or an SMF or an MME. In yet another implementation, for example, the fifth node may be a gNB or a gNB-CU or a gNB-DU or a gNB CU-CP or a gNB CU-UP or an en-gNB or an eNB or a ng-eNB, and the sixth node may be a UE. In yet another implementation, for example, the fifth node is a node where the candidate target cell is located, and the sixth node is a node currently accessed by the UE. In yet another implementation, for example, the fifth node may be a secondary node and/or a target secondary node and/or a Candidate Target Secondary Node in a dual-connectivity, and the sixth node may be a master node in a dual-connectivity. In yet another implementation, for example, the fifth node may be a master node in a dual-connectivity, and the sixth node may be a secondary node and/or a target secondary node and/or a Candidate Target Secondary Node in a dual-connectivity. In yet another implementation, for example, the fifth node may be a secondary node and/or a target secondary node and/or a Candidate Target Secondary Node in a dual-connectivity, and the sixth node may be a secondary node and/or a target secondary node and/or a Candidate Target Secondary Node in a dual-connectivity.

Step 501A: the fifth node transmits handover configuration update information to the sixth node. The handover configuration update information may be the aforementioned fourth message.

Step 502A: the sixth node can make a handover decision based on the received handover configuration update information, and the sixth node can also forward it to other nodes for the other nodes to make handover decisions.

FIG. 5B shows a schematic diagram of an aspect of a method for supporting handover between nodes according to an embodiment of the disclosure. Specifically, FIG. 5B shows a process of exchanging handover configuration update information between nodes, so that the source node and/or cell can obtain the latest handover configuration.

Step 501B: the source node (or the source gNB CU) transmits an LTM handover request to the (candidate) target node (or the (candidate) target gNB CU) to trigger an LTM handover. The LTM handover request may be the fifth message mentioned above. In an implementation, the message may be carried by a handover request message.

Step 502B: the (candidate) target gNB CU and the (candidate) target gNB DU perform a UE context setup and/or modification process.

Step 503B: the (candidate) target node (or the (candidate) target gNB CU) transmits an LTM handover request result to the source node (or the source gNB). The result of the LTM handover request may be the sixth message described above. In an implementation, the message may be carried by a handover request acknowledge message.

Step 504B: the source gNB CU and the source gNB DU perform a UE context modification process and/or an RRC message transfer process, so as to transmit the configuration information of the target cell to the source gNB DU and/or transmit it to the user through the source gNB DU transparently.

Step 505B: the source node (or the source gNB CU) transmits an RRC reconfiguration message to the UE.

Step 506B: the UE transmits an RRC reconfiguration complete message to the source node (or the source gNB CU).

Step 507B: the (candidate) target node (candidate target node 2 in this example) transmits handover configuration update information to the source node. The handover configuration update information may be the aforementioned fourth message. Optionally, the source node CU may transmit the handover configuration update information to the source node DU. Optionally, the source node may transmit the handover configuration update information to another (candidate) target node. The other (candidate) target node CU may transmit the handover configuration update information to the other (candidate) target node DU.

Step 508B: the source node (or the source gNB CU) transmits an RRC reconfiguration message (including updated handover configuration information, for example) to the UE to inform the UE of the updated handover configuration.

Step 509B: the UE transmits an RRC reconfiguration complete message to the source node (or the source gNB CU).

Step 510B: the source cell makes subsequent handover decisions and performs corresponding processes based on the updated handover configuration.

FIG. 5C shows a schematic diagram of an aspect of a method for supporting handover between nodes according to an embodiment of the disclosure. Specifically, FIG. 5C shows a process that when a user accesses one of the target nodes (e.g., target node 1), other target nodes (e.g., target node 2) can transmit handover configuration update information to the source node, and the source node forwards it to the user's new accessing node (e.g., target node 1), for the user's new accessing node (e.g., target node 1) to perform subsequent handover, or the user's new accessing node (e.g., target node 1) may transmit it to other nodes, for the other nodes to perform subsequent handover.

Step 501C: after the user successfully accesses the target node 1, the target node 1 transmits a message that the user successfully accesses the target node 1 to the source node. The information of the user's handover and/or access to a node may be the aforementioned third message.

Step 502C: if the target node 2 needs to update configuration, the target node 2 transmits handover configuration update information to the source node. The handover configuration update information may be the aforementioned fourth message.

Step 503C: since the user has accessed the target node 1, the source node transmits handover configuration update information of the target node 2 to the target node 1. The handover configuration update information may be the aforementioned fourth message.

Step 504C: the target node 1 may forward the handover configuration update information to other nodes and/or use it for making handover decisions. In an implementation, for example, the target node 1 may transmit handover configuration update information to the user for subsequent handover by the user. In another implementation, for example, the target node 1 may make a handover decision or the like based on the handover configuration update information.

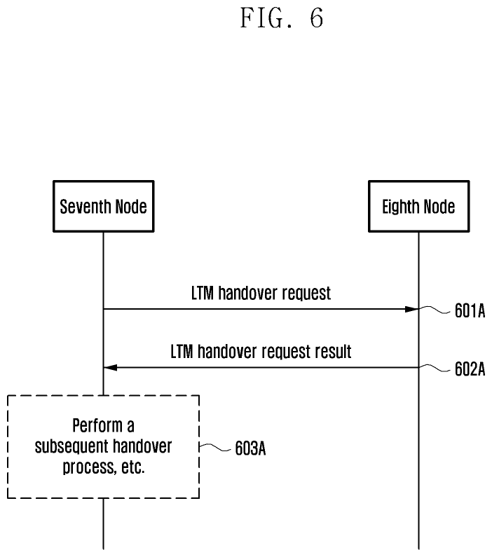

FIG. 6 shows a schematic diagram of an aspect of a method for supporting handover between nodes according to an embodiment of the disclosure. Specifically, FIG. 6 shows a process of exchanging LTM handover request for triggering a handover of LTM between two nodes, for the eighth node to obtain the LTM handover request. If the eighth node can accept and/or partially accept the LTM handover request, it transmits a sixth message containing a result of the LTM handover request to the seventh node, and performs the subsequent handover process. If the eighth node cannot accept the request, it transmits a request failure message to the seventh node, and the seventh node can continue to select other nodes to serve as the target cell, and perform the subsequent handover process. In an implementation, for example, the seventh node may be a gNB or a gNB-CU or a gNB-DU or a gNB CU-CP or a gNB CU-UP or an en-gNB or an eNB or a ng-eNB, and the eighth node may be a gNB or a gNB-CU or a gNB-DU or a gNB CU-CP or a gNB CU-UP or an en-gNB or an eNB or a ng-eNB. In another implementation, for example, the seventh node may be an AMF or an SMF or an MME, and the eighth node may be a gNB or a gNB-CU or a gNB CU-CP or an en-gNB or an eNB or a ng-eNB. In yet another implementation, for example, the seventh node may be a gNB or a gNB-CU or a gNB CU-CP or an en-gNB or an eNB or a ng-eNB, and the eighth node may be an AMF or an SMF or an MME. In yet another implementation, for example, the seventh node may be a gNB or a gNB-CU or a gNB-DU or a gNB CU-CP or a gNB CU-UP or an en-gNB or an eNB or a ng-eNB, and the eighth node may be a UE. In yet another implementation, for example, the seventh node may be a source node in handover, and the eighth node may be a secondary node in handover. In yet another implementation, for example, the seventh node may be a secondary node and/or a target secondary node and/or a Candidate Target Secondary Node in a dual-connectivity, and the eighth node may be a master node in a dual-connectivity. In yet another implementation, for example, the seventh node may be a master node in a dual-connectivity, and the eighth node may be a secondary node and/or a target secondary node and/or a Candidate Target Secondary Node in a dual-connectivity. In yet another implementation, for example, the seventh node may be a secondary node and/or a target secondary node and/or a Candidate Target Secondary Node in a dual-connectivity, and the eighth node may be a secondary node and/or a target secondary node and/or a Candidate Target Secondary Node in a dual-connectivity.

Step 601A: the seventh node transmits an LTM handover request to the eighth node to trigger an LTM handover process. The LTM handover request may be the aforementioned fifth message.

Step 602A: the eighth node feeds back a result of the LTM handover request to the seventh node. The result of the LTM handover request may be the aforementioned sixth message.

Step 603A: the seventh node performs a subsequent handover process based on the received result of the LTM handover request.

In the above example, a source master node and a target secondary node are used as examples, and the disclosure is not limited to the sample contents. For example, the source master node may also be a source node in handover and the target secondary node may also be a secondary node in handover. In this case, in the above example, the secondary node addition request (S-NODE ADDITION REQUEST) message should be replaced with a handover request (HADOVER REQUEST) message, and the secondary node addition request acknowledge (S-NODE ADDITION REQUEST ACKNOWLEDGE) message should be replaced with a handover request acknowledge (HADOVER REQUEST ACKNOWLEDGE) message.

It should be understood that, depending on the application scenarios, various examples, aspects, methods, steps, processes, or the like, described herein can be implemented individually or in combination in any way, and are not limited herein.

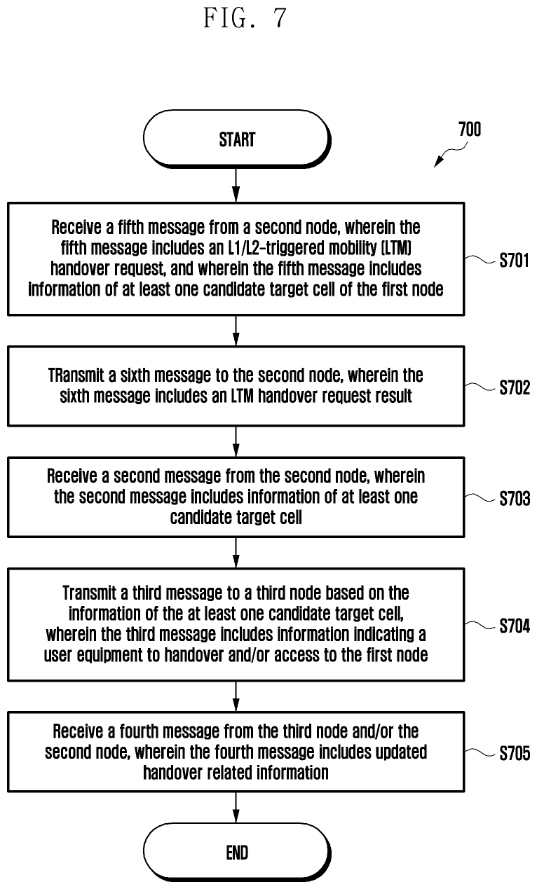

FIG. 7 shows a flowchart of a method 700 performed by a first node in a wireless communication system according to an embodiment of the disclosure.

Referring to FIG. 7, a method 700 performed by a first node in a wireless communication system according to embodiments of the disclosure may include: in operation 8701, receiving a fifth message from a second node, wherein the fifth message includes an L1/L2-triggered mobility (LTM) handover request, and wherein the fifth message includes information of at least one candidate target cell of the first node; in operation S702, transmitting a sixth message to the second node, wherein the sixth message includes an LTM handover request result; in operation S703, receiving a second message from the second node, wherein the second message includes information of at least one candidate target cell; in operation S704, transmitting a third message to a third node based on the information of the at least one candidate target cell, wherein the third message includes information indicating a user equipment to handover and/or access to the first node; and in operation S705, receiving a fourth message from the third node and/or the second node, wherein the fourth message includes updated handover related information.

According to embodiments of the disclosure, the method 700 may further include: transmitting a first message to the second node, wherein the first message includes a request for the information of the at least one candidate target cell, wherein the second message is transmitted to the first node by the second node based on the request for the information of the at least one candidate target cell; wherein, the first message includes one or more of the following: identification of a user equipment related to handover, identification for requesting to report candidate target cell information, identification of a cell requested to report candidate target cell information, scope of candidate target cells requested to report candidate target cell information, and candidate target cell information requested to be reported.

According to embodiments of the disclosure, the method 700 may further include: transmitting a handover success message to the second node, wherein the handover success message includes information indicating that a user equipment has handed over and/or accessed to the first node.

According to embodiments of the disclosure, the method 700 may further include: transmitting a radio resource control reconfiguration message to the user equipment, wherein the radio resource control reconfiguration message includes the updated handover related information.

According to embodiments of the disclosure, candidate target cells included in the second message include one or more of the following: all candidate target cells of all candidate target nodes; all candidate target cells except cells of the first node; all candidate target cells of partial candidate target nodes; partial candidate target cells of partial candidate target nodes; and candidate target cells having an interface with a node to which the user equipment is currently connected.

According to embodiments of the disclosure, the method 700 may further include: making a handover decision based on the information of the at least one candidate target cell and/or the updated handover related information.

According to embodiments of the disclosure, the second message includes one or more of the following: identification of a user equipment related to handover, request index, and reported candidate target cell information.

According to embodiments of the disclosure, the fourth message includes one or more of the following: identification of a user equipment related to handover, updated and/or modified configuration related information, cancelled configuration related information, added configuration related information, valid time of configuration, and related information for obtaining Timing Advance (TA).

According to embodiments of the disclosure, the information of the at least one candidate target cell included in the fifth message includes one or more of the following: identification of a user equipment related to handover, target cell identification, target node identification, LTM handover identification, request for Random Access Channel (RACH) resource configuration for obtaining Timing Advance (TA), reference signal configuration request, and reference configuration.

According to embodiments of the disclosure, the sixth message includes one or more of the following: identification of a user equipment related to handover, identification of accepted target cells, Random Access Channel (RACH) resource configuration for obtaining Timing Advance (TA), reference signal configuration, target node configuration, reference configuration corresponding to target node configuration, identification of unaccepted target cells, and reasons for non-acceptance.

According to embodiments of the disclosure, the third message includes one or more of the following: identification of a user equipment related to handover, identification of a target cell accessed by the user equipment, and identification of a target node accessed by the user equipment.

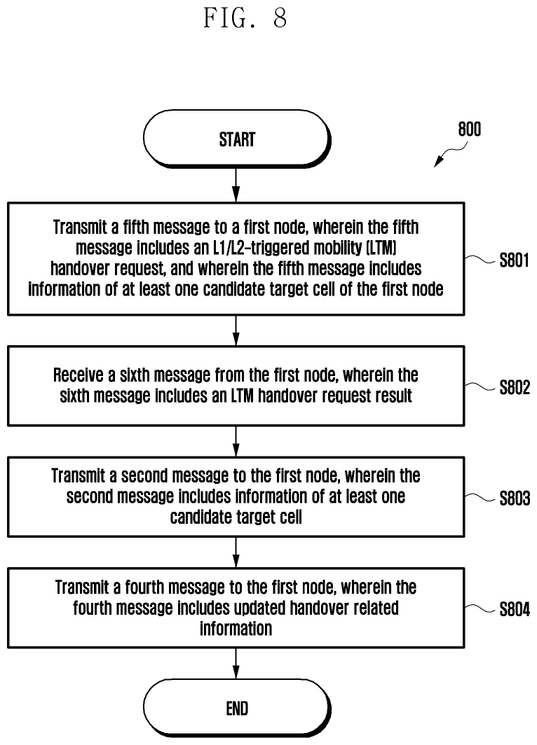

FIG. 8 shows a flowchart of a method 800 performed by a second node in a wireless communication system according to an embodiment of the disclosure.

Referring to FIG. 8, a method 800 performed by a second node in a wireless communication system according to embodiments of the disclosure may include: in operation S801, transmitting a fifth message to a first node, wherein the fifth message includes an L1/L2-triggered mobility (LTM) handover request, and wherein the fifth message includes information of at least one candidate target cell of the first node; in operation S802, receiving a sixth message from the first node, wherein the sixth message includes an LTM handover request result; in operation S803, transmitting a second message to the first node, wherein the second message includes information of at least one candidate target cell; and in operation S804, transmitting a fourth message to the first node, wherein the fourth message includes updated handover related information.

According to embodiments of the disclosure, the method 800 may further include: receiving a first message from the first node, wherein the first message includes a request for the information of the at least one candidate target cell, wherein the second message is transmitted to the first node by the second node based on the request for the information of the at least one candidate target cell.

According to embodiments of the disclosure, the method 800 may further include: receiving a handover success message from the first node, wherein the handover success message includes information indicating that a user equipment has handed over and/or accessed to the first node.

According to embodiments of the disclosure, the method 800 may further include: receiving updated handover related information from a third node; and transmitting a radio resource control reconfiguration message to the user equipment, wherein the radio resource control reconfiguration message includes the updated handover related information.

According to embodiments of the disclosure, candidate target cells included in the second message include one or more of the following: all candidate target cells of all candidate target nodes; all candidate target cells except cells of the first node; all candidate target cells of partial candidate target nodes; partial candidate target cells of partial candidate target nodes; and candidate target cells having an interface with a node to which the user equipment is currently connected.

According to embodiments of the disclosure, the method 800 may further include: making a handover decision based on the updated handover related information.

It should be understood that methods 700, 800, or the like, according to embodiments of the disclosure may further include any steps described in connection with various examples, aspects, drawings, or the like, of the disclosure.

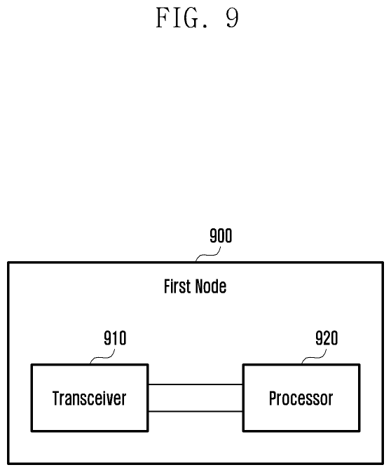

FIG. 9 shows a schematic diagram of a first node 900 according to an embodiment of the disclosure.

Referring to FIG. 9, a first node (or first node device) 900 according to embodiments of the disclosure may include a transceiver 910 and a processor 920. The transceiver 910 may be configured to transmit and receive signals. The processor 920 may be coupled to the transceiver 910 and may be configured to (e.g., control the transceiver 910 to) perform a method performed by a first node according to embodiments of the disclosure.

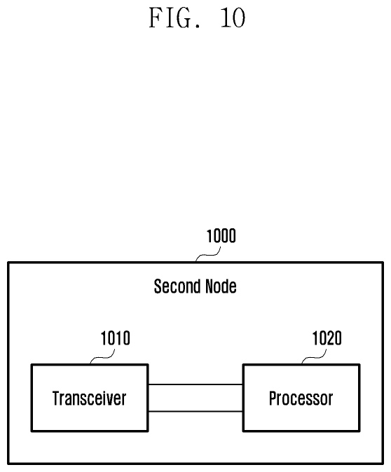

FIG. 10 illustrates a schematic diagram of a second node 1000 according to an embodiment of the disclosure.

Referring to FIG. 10, a second node (or second node device) 1000 according to embodiments of the disclosure may include a transceiver 1010 and a processor 1020. The transceiver 1010 may be configured to transmit and receive signals. The processor 1020 may be coupled to the transceiver 1010 and may be configured to (e.g., control the transceiver 1010 to) perform a method performed by a second node according to embodiments of the disclosure. A processor can also be called a controller.

Embodiments of the disclosure also provide a computer-readable medium having stored thereon computer-readable instructions which, when executed by a processor, implement any method according to embodiments of the disclosure.

Various embodiments of the disclosure may be implemented as computer-readable codes embodied on a computer-readable recording medium from a specific perspective. A computer-readable recording medium is any data storage device that can store data readable by a computer system. Examples of computer-readable recording media may include read-only memory (ROM), random access memory (RAM), compact disk read-only memory (CD-ROM), magnetic tape, floppy disk, optical data storage device, carrier wave (e.g., data transmission via the Internet), or the like. Computer-readable recording media can be distributed by computer systems connected via a network, and thus computer-readable codes can be stored and executed in a distributed manner. Furthermore, functional programs, codes and code segments for implementing various embodiments of the disclosure can be easily explained by those skilled in the art to which the embodiments of the disclosure are applied.

It will be understood that the embodiments of the disclosure may be implemented in the form of hardware, software, or a combination of hardware and software. The software may be stored as program instructions or computer-readable codes executable on a processor on a non-transitory computer-readable medium. Examples of non-transitory computer-readable recording media include magnetic storage media (such as ROM, floppy disk, hard disk, or the like) and optical recording media (such as CD-ROM, digital video disk (DVD), or the like). Non-transitory computer-readable recording media may also be distributed on computer systems coupled to a network, so that computer-readable codes are stored and executed in a distributed manner. The medium can be read by a computer, stored in memory, and executed by a processor. Various embodiments may be implemented by a computer or a portable terminal including a controller and memory, and the memory may be an example of a non-transitory computer-readable recording medium suitable for storing program (s) with instructions for implementing embodiments of the disclosure. The disclosure may be realized by a program with code for concretely implementing the apparatus and method described in the claims, which is stored in a machine (or computer)-readable storage medium. The program may be electronically carried on any medium, such as a communication signal transmitted via a wired or wireless connection, and the disclosure suitably includes its equivalents.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a central unit (CU) of a source base station in a communication system, the method comprising:
transmitting, to at least one CU of a candidate target base station, a layer 1/layer 2 (L1/L2)-triggered mobility (LTM) handover request for triggering an LTM handover;
receiving, from the at least one CU of the candidate target base station, an LTM handover request result message including at least one an identification (ID) of an accepted target cell, information for the accepted target cell or a reason for a non-accepted target cell; and
as a response to the LTM handover request result message, transmitting, to a user equipment (UE), a first radio resource control (RRC) reconfiguration message including configuration information for a target cell.

2. The method of claim 1, the method further comprising:
receiving, from a distributed unit (DU) of the source base station, an LTM cell switch notification message; and
transmitting, to a DU of a target base station via the CU of the target base station, the LTM cell switch notification message.

3. The method of claim 2, the method further comprising:
receiving, from the DU of the target base station via the CU of the target base station, an access success message for a successful access of the UE; and
performing an UE context modification process.

4. The method of claim 3, the method further comprising:
receiving, from the DU of the target base station via the CU of the target base station, a candidate target cell information request message for a subsequent handover including an identification (ID) for requesting candidate target cell information; and
as a response to the candidate target cell information request message, transmitting, to the DU of the target base station via the CU of the target base station, the candidate target cell information including timing advance (TA) information.

5. A method performed by a central unit (CU) of a target base station in a communication system, the method comprising:
receiving, from a CU of a source base station, a layer 1/layer 2 (L1/L2)-triggered mobility (LTM) handover request for triggering an LTM handover;
transmitting, to the CU of the source base station, an LTM handover request result message,
wherein the LTM handover request result message includes at least one an identification (ID) of an accepted target cell, information for the accepted target cell or a reason for a non-accepted target cell.

6. The method of claim 5, the method further comprising:
receiving, from the CU of the source base station, an LTM cell switch notification message; and
transmitting, to a distributed unit (DU) of the target base station, the LTM cell switch notification message.

7. The method of claim 6, the method further comprising:
receiving, from the DU of the target base station, an access success message for a successful access of a user equipment (UE); and
transmitting, to the CU of the source base station, the access success message.

8. The method of claim 7, the method further comprising:
receiving, from the DU of the target base station, a candidate target cell information request message for a subsequent handover an ID for requesting candidate target cell information;
transmitting, to the CU of the source base station, the candidate target cell information request message;
as a response to the candidate target cell information request message, receiving, from the CU of the source base station, the candidate target cell information including timing advance (TA) information; and
transmitting, to the DU of the target base station, the candidate target cell information including the TA information.

9. The method of claim 8, the method further comprising:
receiving, from the DU of the target base station, a handover configuration update message; and
performing an UE context modification process; and
transmitting, to the UE, a second radio resource configuration (RRC) message including updated configuration information for a target cell.

10. A method performed by a user equipment (UE) in a communication system, the method comprising:
receiving, from a central unit (CU) of a source base station, a radio resource control (RRC) reconfiguration message including configuration information for a target cell;
receiving, from a distributed unit (DU) of the source base station, a handover command message; and
as a response to the handover command message, accessing to a DU of a target base station.

11. A central unit (CU) of a source base station in a communication system, the CU of the source base station comprising:
a transceiver; and
a controller coupled with the transceiver, and configured to:
transmit, to at least one CU of a candidate target base station, a layer 1/layer 2 (L1/L2)-triggered mobility (LTM) handover request for triggering an LTM handover,
receive, from the at least one CU of the candidate target base station, an LTM handover request result message including at least one an identification (ID) of an accepted target cell, information for the accepted target cell or a reason for a non-accepted target cell, and
as a response to the LTM handover request result message, transmit, to a user equipment (UE), a first radio resource control (RRC) reconfiguration message including configuration information for a target cell.

12. The CU of the source base station of claim 11, wherein the controller is further configured to:
receive, from a distributed unit (DU) of the source base station, an LTM cell switch notification message, and
transmit, to a DU of a target base station via the CU of the target base station, the LTM cell switch notification message.

13. The CU of the source base station of claim 12, wherein the controller is further configured to:
receive, from the DU of the target base station via the CU of the target base station, an access success message for a successful access of the UE, and
perform an UE context modification process.

14. The CU of the source base station of claim 12, wherein the controller is further configured to:
receive, from the DU of the target base station via the CU of the target base station, a candidate target cell information request message for a subsequent handover including an identification (ID) for requesting candidate target cell information, and
as a response to the candidate target cell information request message, transmit, to the DU of the target base station via the CU of the target base station, the candidate target cell information including timing advance (TA) information.

15. A central unit (CU) of a target base station in a communication system, the CU of the target base station comprising:
a transceiver; and
a controller coupled with the transceiver, and configured to:
receive, from a CU of a source base station, a layer 1/layer 2 (L1/L2)-triggered mobility (LTM) handover request for triggering an LTM handover,
transmit, to the CU of the source base station, an LTM handover request result message,
wherein the LTM handover request result message includes at least one an identification (ID) of an accepted target cell, information for the accepted target cell or a reason for a non-accepted target cell.

16. The CU of the target base station of claim 15, wherein the controller is further configured to:
receive, from the CU of the source base station, an LTM cell switch notification message, and
transmit, to a distributed unit (DU) of the target base station, the LTM cell switch notification message.

17. The CU of the target base station of claim 16, wherein the controller is further configured to:
receive, from the DU of the target base station, an access success message for a successful access of a user equipment (UE), and
transmit, to the CU of the source base station, the access success message.

18. The CU of the target base station of claim 17, wherein the controller is further configured to:
receive, from the DU of the target base station, a candidate target cell information request message for a subsequent handover an ID for requesting candidate target cell information,
transmit, to the CU of the source base station, the candidate target cell information request message,
as a response to the candidate target cell information request message, receive, from the CU of the source base station, the candidate target cell information including timing advance (TA) information; and
transmit, to the DU of the target base station, the candidate target cell information including the TA information.

19. The CU of the target base station of claim 18, wherein the controller is further configured to:
receive, from the DU of the target base station, a handover configuration update message; and
perform an UE context modification process; and
transmit, to the UE, a second radio resource configuration (RRC) message including updated configuration information for a target cell.

20. A user equipment (UE) in a communication system, the UE comprising:
a transceiver; and
a controller coupled with the transceiver, and configured to:
receive, from a central unit (CU) of a source base station, a radio resource control (RRC) reconfiguration message including configuration information for a target cell,
receive, from a distributed unit (DU) of the source base station, a handover command message, and
as a response to the handover command message, access to a DU of a target base station.
